(19) United States
(12) Patent Application Publication
(10) Pub. No.: US 2025/0005942 A1
(43) Pub. Date: Jan. 2, 2025

(54) DETECTION AND IDENTIFICATION OF DEFECTS USING ARTIFICIAL INTELLIGENCE ANALYSIS OF MULTI-DIMENSIONAL INFORMATION DATA

(71) Applicants: Jessica White, New York, NY (US); Trustees of Tufts College, Medford, MA (US); Research Foundation of the City University of New York, New York, NY (US)

(72) Inventors: Karen A. Panetta, Rockport, MA (US); Sos S. Agaian, New York, NY (US); Shishir Paramathma Rao, Burlington, MA (US); Srijith Rajeev, Burlington, MA (US); Shreyas Kamath Kalasa Mohandas, Burlington, MA (US); Rahul Rajendran, Belleville, MI (US); Jessica White, New York, NY (US)

(73) Assignees: Trustees of Tufts College, Medford, MA (US); Research Foundation of the City University of New York, New York, NY (US)

(21) Appl. No.: 18/712,019

(22) PCT Filed: Nov. 22, 2022
(86) PCT No.: PCT/US2022/050741

§ 371 Date: May 21, 2024

Related U.S. Application Data
(60) Provisional application No. 63/282,353, filed on Nov. 23, 2021.

(51) Int. Cl. G06V 20/68; G06T 7/00; G06V 10/143; G06V 10/58; G06V 10/764; G06V 10/77; G06V 10/82; G06V 20/69

(52) U.S. Cl. CPC G06V 20/68; G06T 7/0002; G06V 10/143; G06V 10/58; G06V 10/764; G06V 10/7715; G06V 10/82; G06V 20/698; G06T 2207/10056; G06T 2207/20081; G06T 2207/20084; G06T 2207/30128

(57) ABSTRACT

Methods, apparatus and program products for acquiring and analyzing images of a sample. An artificial intelligence (AI) module may be trained to identify, within multi-dimensional image data corresponding to images of objects, wavelength patterns corresponding to one or more defects within the objects. An analysis module is configured to detect one or more defects in the sample using the AI module for analyzing the images of the sample. In some embodiments, the samples are food samples and the defects include one or more pathogens.

### BACKGROUND

As is known in the art, there are many systems that can be used to inspect objects based on various criteria. For example, image processing refers to systems that process inputs, such as photographs, video etc., to generate some type of output. Many image-processing techniques involve treating the image as a two-dimensional (2D) signal and applying conventional signal-processing techniques. Examples of image processing include image enhancement, restoration, image compression, segmentation, recognition, and image smoothing.

There are a variety of image processing systems for detecting an item or region having certain characteristics. For example, a conventional image processing system may inspect an object using known red-green-blue (RGB)-based processing techniques to detect whether an image contains a known region having defined characteristics. While such systems may be suitable for some applications, conventional systems may be inadequate for other applications.

For instance, predicting vegetables' softness, quality, and microbial spoilage may not be achieved using RGB systems. Similarly, known food safety management systems using conventional hazard-based approaches may be inefficient and/or inaccurate. Foodborne pathogens cause a great number of diseases with significant effects on human health. Foodborne illness, e.g., food poisoning, is often caused by consuming food contaminated by bacteria and/or their toxins, parasites, viruses, chemicals, or other agents. While a food supply may be relatively safe, there may still be millions of cases of foodborne illness each year, which incur significant economic and societal costs.

Foodborne illness occurs when a pathogen is ingested with food and establishes itself in a human host, or when a toxigenic pathogen establishes itself in a food product and produces a toxin, which the human host then ingests. Thus, foodborne illness is generally classified into: (a) foodborne infection and/or (b) foodborne intoxication. Since an incubation period is usually involved in foodborne infections, the time from ingestion until symptoms occur is longer than that of foodborne intoxications.

Bacteria, viruses, and parasites are the most common cause of foodborne diseases and exist in a variety of shapes, types, and properties. Some of the most common pathogens include Bacillus cereus, Campylobacter jejuni, Clostridium botulinum, Clostridium perfringens, Cronobacter sakazakii, Esherichia-coli, Listeria monocytogenes, Salmonella spp., Shigella spp., Staphylococcus aureus, Vibrio spp. and Yersinia enterocolitica, Norovirus, Salmonella, Clostridium perfringens, Campylobacter, Staphylococcus aureus (Staph), Clostridium botulinum (botulism), Listeria, Escherichia coli (E. coli), and Vibrio.

Implicated food vehicles may be from synthetic, plant, and animal origin. Routine pathogen testing methods, such as culture-based methods using selective media, are still the gold standard, but confirmation of the results may require extra days for sample incubation. Long testing times, small sample sizes, and human handling may delay food entering commerce, increase instances of cross-contamination, and under-detect contamination.

Attempts to develop optical detection approaches have primarily relied on the generation and detection of fluorescence, Raman, or a combination of other specifically excited signals-methods that may require powerful, hazardous, and costly excitation sources such as high-powered lasers, along with high concentrations of the pathogens. These approaches involve days-long sample preparation, enrichment, and incubation. In addition, instruments based on these mechanisms typically cannot differentiate between serotypes and species. In the non-optical space, currently, nucleic acid-based polymerase chain reaction (PCR) methods may be used to detect target pathogens. However, the high recurring cost of such methods is an issue. In addition, LAMP (loop-mediated isothermal amplification) can be used, for example, in some 3M assays.

### SUMMARY

Example embodiments of the disclosure provide methods, apparatus, and program products that detect one or more defects in a sample using an artificial intelligence (AI) module configured to analyze images/videos of the sample. In embodiments, the AI module is trained to identify, within multi-dimensional information data, such as hyperspectral image data, corresponding to images of objects and wavelength patterns corresponding to one or more defects within the objects. In example embodiments, the samples comprise food, and the defects comprise pathogens.

Exemplary embodiments of the disclosure may include an AI system that measures the color temperature of the images during acquisition. The AI system may classify and recognize defects, such as pathogens, or other types of irregularities, in a color-temperature-agnostic manner. In some embodiments, an AI system has a multidimensional neural network implementation with dedicated dimensions for different components of multi-dimensional information data, such as hyper-spectral data. In example embodiments, in food-borne pathogen detection applications, food-borne pathogens are detected and classified in real-time and in a laboratory or non-laboratory settings.

In one aspect, a system comprises: an imager to acquire images of a sample; an artificial intelligence (AI) module trained to identify, within multi-dimensional information data, such as hyperspectral image data, corresponding to images of objects, wavelength patterns corresponding to one or more defects within the objects; and an analysis module configured to detect, using the AI module, one or more defects in the sample based on wavelength patterns of one or more defects within the acquired images of the sample.

In one aspect, a system comprises: an imager to acquire images of a sample; the imager comprises a device configured to collect color temperature data of the sample; an artificial intelligence (AI) module trained to identify, within multi-dimensional information data, such as hyperspectral image data, corresponding to images of objects, wavelength patterns corresponding to one or more defects within the objects; and an analysis module configured to detect, using the AI module, one or more defects in the sample based on wavelength patterns of one or more defects within the acquired images of the sample.

A system according to exemplary embodiments of the present disclosure can include one or more of the following features in any combination: the analysis module is configured to classify and/or map the detected defect, the imager comprises an imager configured to collect multi-dimensional image data for the sample, the imager comprises a camera of a mobile phone to collect images of the sample, the imager comprises a handheld microscope to collect the images of the sample, the imager comprises a device configured to collect color temperature data of the sample, the system comprises a stationary inspection system, a conversion module configured to convert the acquired images to multi-dimensional images, the conversion module is configured to normalize luminance level for the sample and the acquired images for the conversion of the acquired images to the multi-dimensional images, a light sensing device configured to detect a luminance level for the sample, the artificial intelligence module is trained with a training set of multi-dimensional images processed to classify spatio-spectral signatures for the defects, a data augmentation module that augments the multi-dimensional image data with synthesized multi-dimensional data, the data augmentation module comprises a generative adversarial network (GAN), the AI module comprises a hypercomplex neural network, the neural network comprises three-dimensional convolutional (3D CNN) data representations, the neural network comprises quaternion data representations, the neural network comprises octonion data representations, a visualization module configured to generate a display of the acquired images and the detected defect, the visualization module comprises an RGB visualization display, the defects comprise pathogens, and the wavelength patterns each correspond to a particular pathogen, a data reduction module configured to reduce a number of dimensions of the multi-dimensional data, the data reduction module is configured to use Deep Hypercomplex Data Reduction (DHDR), the sample comprises food and the defects comprises pathogens, the sample is an abiotic object and the defects comprise pathogens, the system is configured to detect defects in real time, the system is configured to detect defects in a non-laboratory setting, the analysis module is configured to process the multi-dimensional image data as a stack of one-dimensional (1D) signals, the system is configured to mask at least a portion of the multi-dimensional image data, the system is configured to process the multi-dimensional image data using a defect classification hierarchy, the system is configured to use different neural networks for different levels of the defect classification hierarchy, the imager further comprises an extension tube, the imager further comprises at least one lens to filter out selected wavelengths, the imager further comprises a hyperspectral array imager comprising an array of unique wavelength filter lenses, a feature recalibration module to enhance content of interest in the images of the object, the feature recalibration module includes a spectral attention selection processing path, the feature calibration module includes a spatial attention selection processing path, the feature recalibration module includes a spectral attention selection processing path and/or a spatial attention selection processing path having a pooling module, the feature recalibration module includes a fully connected layer coupled between the pooling module and a range-fitting module, the feature recalibration module includes a combiner to combiner an output of the range-fitting module and an original input to the pooling module, and/or the feature recalibration module comprises a quaternion network.

In another aspect, a method comprises: acquiring images of a sample with an imager; identifying, within multi-dimensional image data corresponding to images of objects, wavelength patterns corresponding to one or more defects within the objects using a trained artificial intelligence (AI) module; and detecting one or more defects in the sample using the trained AI module.

A method can further include one or more of the following features in any combination: classifying and/or mapping the detected defect, the classifying and/or mapping comprises per-pixel processing and sub-pixel-level material classification, the classifying and/mapping comprises Deep Hypercomplex based Reversible DR (DHRDR) processing for classification, the classifying and/or mapping comprises generating an output that is 1D for image level classification and 2D for pixel level classification, the imager comprises an imager configured to collect multi-dimensional image data for the sample, the imager comprises a camera of a mobile phone to collect images of the sample, the imager comprises a handheld microscope to collect the images of the sample, the imager comprises a device configured to collect color temperature data of the sample, the system comprises a stationary inspection system, converting the acquired images to multi-dimensional images, normalizing luminance level for the sample and the acquired images for the conversion of the acquired images to the multi-dimensional images, detecting a luminance level for the sample, the artificial intelligence module is trained with a training set of multi-dimensional images processed to classify spatio-spectral signatures for the defects, augmenting the multi-dimensional image data with synthesized multi-dimensional data, employing a generative adversarial network (GAN) for augmenting the multi-dimensional image data, the artificial intelligence module comprises a hypercomplex neural network, the neural network comprises three-dimensional convolutional (3D CNN) data representations, the neural network comprises quaternion data representations, the neural network comprises octonion data representations, generating a display of the acquired images and the detected defect, the display comprises an RGB visualization display, the defects comprise pathogens, and the wavelength patterns each correspond to a particular pathogen, reducing a number of dimensions of the multi-dimensional data, reducing the number of dimensions using Deep Hypercomplex Data Reduction (DHDR), the sample comprises food and the defects comprises pathogens, the sample comprises an abiotic object and the defects comprise pathogens, detecting defects in real time, detecting the defects in a non-laboratory setting, the analysis module is configured to process the multi-dimensional image data as a stack of one-dimensional (1D) signals, the system is configured to mask at least a portion of the multi-dimensional image data, the system is configured to process the multi-dimensional image data using a defect classification hierarchy, the system is configured to use different neural networks for different levels of the defect classification hierarchy, the imager further comprises an extension tube, the imager further comprises at least one lens to filter out selected wavelengths, the imager further comprises a hyperspectral array imager comprising an array of unique wavelength filter lenses, employing feature recalibration module for enhancing content of interest in the images of the object, the feature recalibration module includes a spectral attention selection processing path, the feature calibration module includes a spatial attention selection processing path, the feature recalibration module includes a spectral attention selection processing path and/or a spatial attention selection processing path having a pooling module, the feature recalibration module includes a fully connected layer coupled between the pooling module and a range-fitting module, the feature recalibration module includes a combiner to combiner an output of the range-fitting module and an original input to the pooling module, and/or the feature recalibration module comprises a quaternion network.

A system, according to an exemplary embodiment of the present disclosure, comprises: (A) one or more processors; and (B) a non-transitory computer-readable medium operatively connected to one or more processors having instructions stored thereon which, when executed by the one or more processors, cause one or more processors to perform a method comprising: acquiring images of a sample with an imager; and detecting, using an artificial intelligence (AI) module, one or more defects in the sample by identifying wavelength patterns corresponding to the one or more defects, wherein the AI module has been trained to identify, within multi-dimensional image data corresponding to images of objects, wavelength patterns corresponding to one or more defects within the objects.

### BRIEF DESCRIPTION OF THE DRAWINGS

The foregoing features of this disclosure, as well as the disclosure itself, may be more fully understood from the following description of the drawings in which:

FIG. 1A shows an example system to collect image data according to an exemplary embodiment of the present disclosure;

FIG. 1B is a graphical representation of example spectrum data from the system of FIG. 1A;

FIG. 2 is a representation of a hyperspectral data cube that can be processed by DHDR and/or DHRDR according to an exemplary embodiment of the present disclosure;

FIG. 3 is a block diagram of an example cascade GAN network for synthetic HS image generation according to an exemplary embodiment of the present disclosure;

FIG. 4 is a system for performing mixed hypercomplex CNN according to an exemplary embodiment of the present disclosure;

FIGS. 4A and 4B are example systems to process data having quaternion NN processing according to an exemplary embodiment of the present disclosure;

FIG. 4C shows an illustrative embodiment of an example feature recalibration processing utilizing a spectral attention mechanism;

FIG. 4D shows an example parametric spatial-spectral attention mechanism that may be used for feature recalibration;

FIG. 4E shows an example quaternion parametric spatial and spectral attention network which can be considered a quaternion implementation of the system of FIG. 4D;

FIG. 4F is a graphical representation of hyperspectral images perceived as 1D signals;

FIG. 5A is a graphical representation of HS data having four groups;

FIG. 5B is a representation of a CNN having a 3S kernel and feature map according to an exemplary embodiment of the present disclosures;

FIG. 5C is a representation of a hypercomplex CNN using a linear combination of 3D kernels according to an exemplary embodiment of the present disclosure;

FIGS. 5D-5G are graphical representations showing example ways quaternions can be generated from splitting hyperspectral images;

FIG. 5H shows a high-level implementation of a system having machine-learning hand-crafted features in image space to increase the quality of output classification

FIG. 5I shows a simplified version of ML-based features and conventional HS cubes.

FIG. 5J shows the mean, variance, and standard deviation of the principal component analysis of each hyperspectral cube;

FIG. 5K shows the mean, variance, and standard deviation of the principal component analysis of each hyperspectral cube;

FIG. 5L shows a combination of the approaches shown in FIGS. 5J and 5K;

FIGS. 6A-6C show experimental results for classification under varying lighting conditions according to an exemplary embodiment of the preset disclosure;

FIG. 7 is a representation of a stationary inspection system for defect detection in samples according to an exemplary embodiment of the present disclosure;

FIG. 7A is a representation of a portable device for defect detection in samples according to an exemplary embodiment of the present disclosure;

FIG. 7B is a representation of a camera-based device for having defect detection in samples according to an exemplary embodiment of the present disclosure;

FIG. 7C is a representation of an imaging device having an extension tube increasing spatial resolution for defect detection in samples according to an exemplary embodiment of the present disclosure;

FIG. 7D shows an example imaging system, and FIG. 7E shows an example hyperspectral array imager for the system of FIG. 7D according to exemplary embodiments of the present disclosure;

FIG. 7E shows an example hyperspectral array imager including an array of unique wavelength filter lenses;

FIG. 7F is an example imaging system having a lens positioned in relation to a hyperspectral array imager according to an exemplary embodiment of the present disclosure;

FIG. 8 shows an inspection system and processing to detect defects in a sample using multi-dimensional image analysis by AI processing according to an exemplary embodiment of the present disclosure;

FIG. 8A shows an example defect classification hierarchy according to an exemplary embodiment of the present disclosure;

FIG. 9A is an image of a corn leaf having regions of rust with positions indicated;

FIG. 9B is a graphical representation of spectral information for the image of FIG. 9A with infected and clean regions indicated according to an exemplary embodiment of the present disclosure;

FIG. 10 shows classification results using example embodiments of the disclosure for ETEC vs DI;

FIG. 11 shows classification results for ECN vs DI;

FIG. 12 shows validation accuracy for ETEC-ECN; and

FIG. 13 is a schematic representation of an example computer system that can perform at least a portion of the processing described herein according to an exemplary embodiment of the present disclosure.

### DETAILED DESCRIPTION

Before describing example embodiments of the disclosure, some information is provided. Multi-dimensional (N-D) image data includes any class of images from RGB, multispectral, hyperspectral image data, Red-Green-Blue-Thermal (RGB-T), multi-dimensional metadata, and the like. While example embodiments of the disclosure may be described in conjunction with hyperspectral image data, it is understood that any type of multi-dimensional information data can be used to meet the needs of a particular application. Hyperspectral (HS) imaging is a three-dimensional (3D) spatial and spectral imaging technique that creates hypercubes, which can be viewed as a stack of two-dimensional (2D) images or a grid of one-dimensional (1D) signals. HS images can provide a better diagnostic capability for detection, classification, and discrimination than RGB imagery because of their high spectral resolution. The increase in dimensionality may lead to sparse data distribution that may be difficult to model and may introduce band reduction and processing challenges. Artificial intelligence (AI) modules may include automatic and hierarchical learning processes that can create models with a suitable data representation for classification, segmentation, and detection. Hypercubes require relatively large storage space, expensive computation, and communication bandwidth, which may make them impractical for real-time applications.

Hyperspectral cameras capture the spectrum of each pixel in an image to create hypercubes of data. By comparing the spectra of pixels, these imagers can discern subtle reflected color differences indistinguishable from the human eye or even from color (RGB) cameras. Spatial information is used to monitor the sample as it can extract the chemical mapping of the sample from a hypercube.

A common algorithm in microscopy is linear spectral unmixing, which assumes that the spectrum of each pixel is a linear combination (weighted average) of all end-members in the pixel, and, thus, requires a priori knowledge (i.e., reference spectra). Various algorithms, such as linear interpolation, are used to solve n (number of bands) equations for each pixel, where n is greater than the number of end-member pixel fractions.

Many known machine learning methods available to facilitate this work represent large matrices of spectral data as vectors in a n-dimensional space. For example, principal component analysis (PCA) can simplify complexity in high-dimensional data while retaining trends and patterns by transforming data into fewer dimensions to summarize features. PCA geometrically projects data onto lower dimensions (called principal components); it aims to summarize a dataset using a limited number of components by minimizing the total distance between the data and their projections.

K-Means is an iterative clustering algorithm that classifies data into groups, starting with randomly determined cluster centers. Each pixel in the image is then assigned to the nearest cluster center by distance, and each center is then re-computed as the centroid of all pixels assigned to the cluster. This process repeats until the desired threshold is achieved.

Example embodiments of the disclosure include AI processing to enhance the extraction of useful information from HS cameras, including data from a range of wavelengths to enable a deep HS imaging framework. In some embodiments, hypercomplex-based processing utilizes the high correlation between the bands to generate analytics that improves classification performance over conventional techniques. Hyperspectral data is selected from various sources, data augmentation methodologies are tailored for HS imaging, and neural networks are used to generate new data where the availability of data is limited. In embodiments, mixed hypercomplex neural networks use a combination of hypercomplex algebras to solve various tasks, such as data generation, classification, and segmentation. The spectral information is analyzed for tasks, such as object detection and recognition, that are more discernable for human perception, thereby increasing detection accuracy.

It is understood that the metabolic activity of microorganisms on food may result in biochemical changes with the concurrent formation of metabolic by-products, potentially indicating contamination. While example embodiments of the disclosure may be described in conjunction with detecting pathogens as defects in a food sample, it is understood that hyperspectral images can be analyzed using AI to detect a wide range of defect types, such as pathogens, fungus, toxins, allergens, foreign objects, chemicals, disease, medical irregularity on imaging, Campylobacter, Clostridium perfringen, E. coli, Listeria, Norovirus, Salmonella, Bacillus cereus, Botulism, Hepatitis A, Shigella, Staphylococcus aureus (Staphylococcal [Staph] Food Poisoning), Vibrio Species Causing Vibriosis, and Cyclospora, on a wide range of sample types, such as plastic, metals, glass, wood, liquids, rice, honey, unpasteurized (raw) milk, chicken, shellfish, turkey, beef, poultry, pork, plants, fruits, nuts, eggs, sprouts, raw fruits and vegetables, contaminated water, including drinking untreated water and swimming in contaminated water, animals, shellfish, uncooked/reheated food, and the like. Although various exemplary embodiments of the present invention may be used to detect defects, it should be understood that the present invention is not limited to this application, and other exemplary embodiments may involve the detection of other types of regions and/or objects within a sample besides defects.

HS imaging takes into account that radiations absorbed, reflected, transmitted or emitted by different materials are a function of the wavelength. Based on these reflective or emittance properties, it is possible to identify various materials uniquely. In contrast to traditional imaging modes where information is embedded in the pixel's spatial arrangement, in example embodiments of the disclosure, each pixel of HS data provides the materials' spectral information within the pixel. This feature allows for per-pixel processing and accurate sub-pixel-level material classification.

In general, the current available HS imagery datasets range from a single image dataset to a couple of hundred images. In embodiments, a dataset includes thousands of annotated HS images per stock culture. Examples of current available HS imagery datasets include T. Skauli and J. Farrell, “A collection of hyperspectral images for imaging systems research,” in Digital Photography IX, 2013, vol. 8660, p. 86600C: International Society for Optics and Photonics, (2020). Available: http://www.cvc.uab.es/color_calibration/Bristol_Hyper/, (2020). MultiSpecÂ®|Tutorials. Available: https://engineering.purdue.edu/˜biehl/MultiSpec/hyperspectral.html, and A. Chakrabarti and T. Zickler, “Statistics of real-world hyperspectral images,” in CVPR 2011, 2011, pp. 193-200: IEEE, all of which are incorporated herein by reference in their entirety.

In one aspect of the disclosure, HS data may be augmented, which may be desirable if the amount of labeled data is limited. An enhanced defect database may be generated from collected images that are annotated to enable processing by one or more AI modules. In addition, the defect database may be augmented using synthetic images to enhance the detection, classification, and/or mapping of defects.

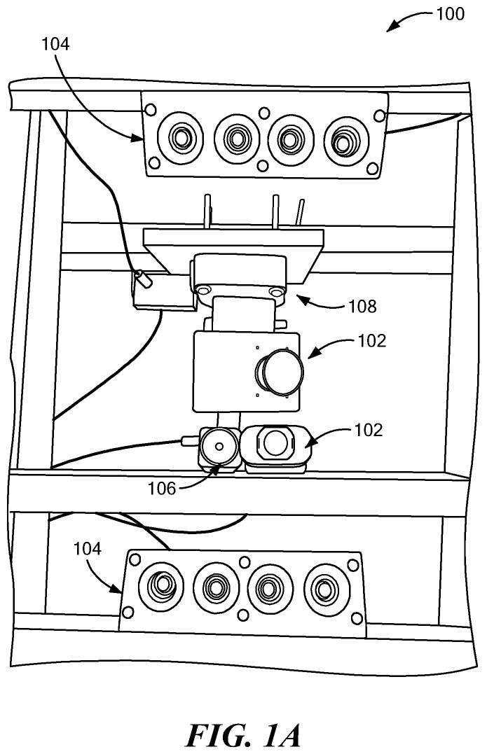

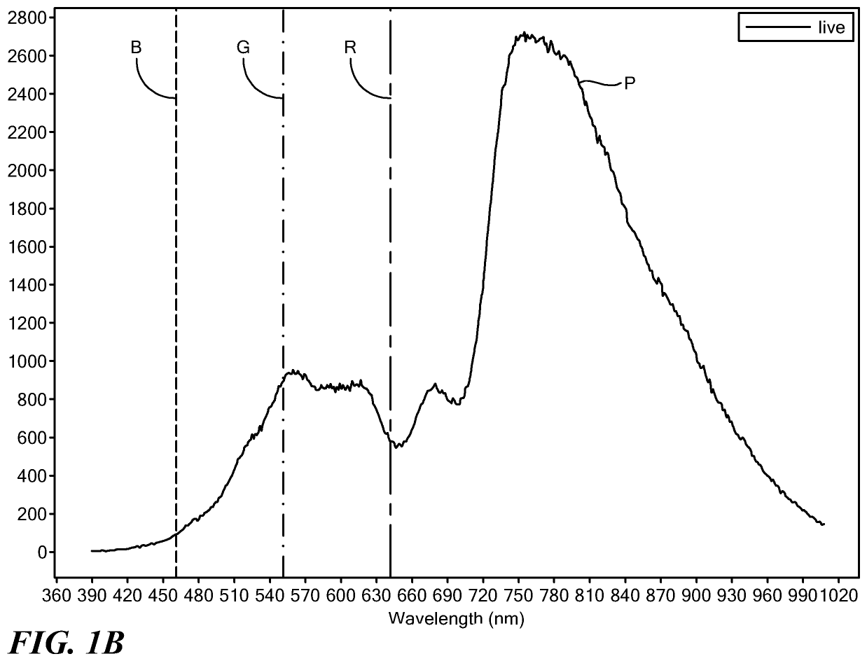

FIG. 1A shows an example imaging system 100 for generating an HS imagery dataset in accordance with an exemplary embodiment of the present disclosure. FIG. 1A shows example spectral data for one pixel, including red R, green G, and blue B wavelengths and a peak response P at about 780 nm. In example embodiments, the HS images are collected from food samples with various defects, such as pathogen presence. The imaging system 100 includes a hyperspectral camera 102 for imaging one or more samples. One or more illumination sources 104 can illuminate the samples to the desired level. A thermal camera 106 can collect temperature information for the sample(s). To collect the sample image data, a rotary mirror 108 can manipulate the hyperspectral camera 102 to the desired position.

It is understood that any suitable imaging devices can be used to collect the HS images. One example imaging device includes a Pika-XC2 imager from RESONON, which utilizes push-broom or line scanning techniques to acquire visible and near-infrared HS images. Example settings comprise a range of 400-1000 nm with 2.3 nm spectral resolution and 1.3 nm spectral sampling for creating the dataset. In one particular embodiment, each HS image has a spatial resolution of about 1200×1600 and a spectral resolution of 447 bands.

In some embodiments, it may be desirable to reduce the dimensionality of HS data to reduce storage space requirements, for example. Dimensionality reduction (DR) transforms the original data's high-dimensional space to a lower-dimensional space while preserving as many essential features as possible. DR technique is a preprocessing step in HS systems that may be performed to reduce the storage space requirements and increase the accuracy and efficiency of the classification system. While HS images' higher spectral resolution may enhance material detection, it may increase the computational and space complexity and lead to the so-called Hughes phenomenon. Additionally, adjacent bands may exhibit a high degree of spatial correlation and contain a high amount of redundancy that may be mitigated by DR. In embodiments, DR can be achieved by techniques such as, for example, feature extraction and/or by band selection. In feature extraction, the original data is transformed into a smaller dimension feature space with specific criteria. Despite obtaining good results in some cases, these methods are computationally expensive and may lead to the loss of critical information about band correlation. In contrast, traditional band selection methods rely on linear transformations to select the significant subset of bands and ignore inter-band nonlinearity. Furthermore, many conventional methods process each spectral band as a separate image and disregard the spectral band inter-relationship.

In embodiments, DR may be performed for displaying HS data and/or for HS data analytics. Mathematically, DR can be formulated as a transformation of dataset X with N images of dimensions (W×H×D), into a new dataset Y with N images of dimensions (W×H×d), such that d<<D, where, W, H are the width and height of the HS image, respectively, and D, d are the number of channels. The value of d is use-case dependent, for example, d=3 for displaying HS data on color monitors, d=4i+1 or d=8i+1 (i=1, 2, 3, . . . n), for combining one, two, and 3-dimensional quaternion or octonion HS data processing, respectively. In embodiments for displaying HS data, DR processing is based on deep hypercomplex architectures, as described more fully below. Existing band selection methods may not produce human consumable color visualizations due to a random selection of bands with the highest information or low correlation.

In contrast, in accordance with example embodiments, Deep Hypercomplex DR (DHDR) for display uses an objective function corresponding to human visual cognition and discriminability. An objective function ensures that the information loss while reducing the dimensions is minimized, preserves edge features that play a role in the human vision for discerning objects, and ensures consistent rendering, implying that any given spectrum is rendered with the same color across images. In embodiments, information and edge objective functions utilize the human visual system based on certain measures, such as those shown and described in K. A. Panetta, E. J. Wharton, and S. S. Agaian, “Human visual system-based image enhancement and logarithmic contrast measure,” IEEE Transactions on Systems, Man, and Cybernetics, Part B (Cybernetics), vol. 38, no. 1, pp. 174-188, 2008, K. Panetta, C. Gao, S. S Agaian, and S. Nercessian, “A new reference-based edge map quality measure,” IEEE Transactions on Systems, Man, and Cybernetics: Systems, vol. 46, no. 11, pp. 1505-1517, 2016, and K. Panetta, A. Samani, S. Agaian, “Choosing the optimal spatial domain measure of enhancement for mammogram images,” International journal of biomedical imaging, vol. 2014, 2014, all of which are incorporated herein by reference. Render-specific objective functions should ensure that same-class objects within an image and across different images have similar color rendition. A patch-wise color measure, such as K. Panetta, A. Samani, S. Agaian, (2014) “Choosing the optimal spatial domain measure of enhancement for mammogram images, International journal of biomedical imaging, 2014, the contents of which are incorporated herein by reference in their entirety, can further include a global per-class average rendition value to achieve this goal.

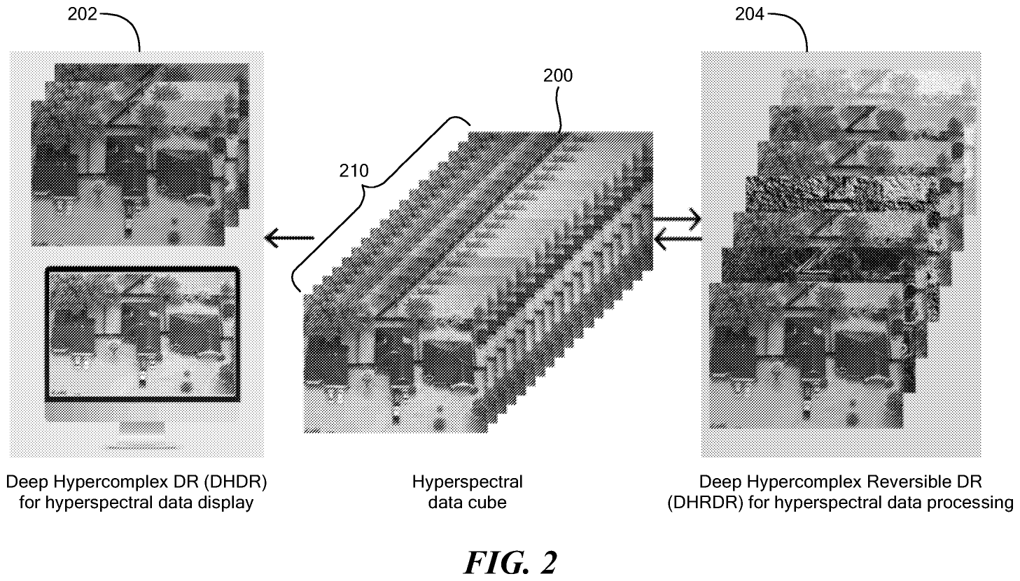

FIG. 2 shows an example representation of an HS data cube 200 that may be processed with a Deep Hypercomplex DR (DHDR) module 202 for HS data display and/or a Deep Hypercomplex Reversible DR (DHRDR) module 204 for HS data processing. For DR methods specific to HS data processing, since displaying HS data is not the objective, it is possible to transform the data into feature space that may not be pleasing to the human eye. As seen in FIG. 2, for example, the various channels 210 of the cube in data processing DR have features that may not be present in the original data since the information from multiple channels of the original data is captured in fewer channels while maintaining the relationship and information content.

Existing methods use classification-aimed criteria, unmixing-aimed criteria, other task-specific criteria, clustering-based, sparsity-based, and embedded learning-based methods to perform DR. These methods have some disadvantages, such as irreversibility of the process, poor generalizability due to task-specific training, and high computation cost for large dataset.

In embodiments, Deep Hypercomplex based Reversible DR (DHRDR) system is used so that DR processing is reversible. Training may be performed with reversibility criteria, where the generated feature space data encapsulates the original data in a task-agnostic manner. Example DHRDR embodiments can provide search-and-rescue specific tasks, such as classification, super-resolution, and object detection.

In embodiments, a cascade GAN network can be used for realistic synthetic multi-dimensional image generation. Data augmentation refers to synthesizing new samples that follow the original data distribution. Current data augmentation techniques for computer vision tasks such as cropping, padding, simple affine transformations of scaling and rotation, elastic transformations, and horizontal flipping, albeit applicable to HSI, do not exploit all the information available to create new data. Known HS-based augmentation techniques include altering the illumination of the images, adding noise, GAN based processing, quadratic data mixture modelling, smoothing based data augmentation, and label-based augmentation processing. While there are some advantages to these augmentation techniques in increasing the sample space and increasing classifier accuracy, they work on a single aspect, such as spatial variations (computer vision-based augmentation) or spectral (HSI-specific augmentation) and do not exploit the spectral-spatial relation of HSI.

In embodiments, data augmentation can be performed using classical approaches, such as, for example, changing intensity, rotating, and/or flipping, or using dynamic approaches, such as GANs.

In embodiments, data augmentation is performed that exploits additional information of HSI, including spectral, spatial, spectral variability, and spectral-spatial relation. The variability in the augmented dataset enables GAN-based augmentation that achieves spectral-spatial mixing. With the dataset including different variations of light and color temperature, the augmentation processing creates synthetic images with a realistic blend, further enhancing the data's robustness. Example GAN structures improve the realism of the generated synthetic images.

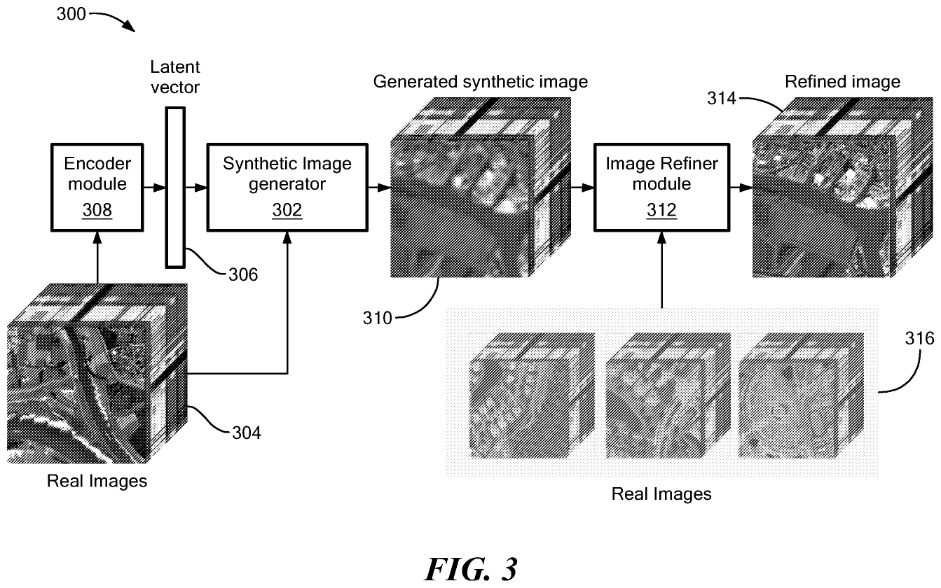

FIG. 3 shows an example data augmentation module 300 that can include a cascade GAN network to generate realistic synthetic HS images. A synthetic image GAN 302 is coupled to a dataset of real images 304 and a latent vector 306. An encoder 308 receives data from the dataset of real images 304 and provides output data to the synthetic image GAN 302, which generates synthetic images 310. An image refiner GAN 312 can refine the synthetic images 310 and generate a refined image 314. Real image information 316 can be provided to the image refiner GAN 312.

Illustrative synthetic image GAN 302 processing is shown and described in A. Shrivastava, T. Pfister, O. Tuzel, J. Susskind, W. Wang, and R. Webb, “Learning from simulated and unsupervised images through adversarial training,” in Proceedings of the IEEE conference on computer vision and pattern recognition, 2017, pp. 2107-2116, and C. Atapattu and B. Rekabdar, “Improving the realism of synthetic images through a combination of adversarial and perceptual losses,” in 2019 International Joint Conference on Neural Networks (IJCNN), 2019, pp. 1-7: IEEE, which are incorporated herein by reference.

The input to the image refiner GAN 312 is the synthetic image generated by the synthetic image GAN 302 instead of a random noise vector as in conventional systems, such as those cited above. This enables network 300 to improve the realism of the generated synthetic images 310. Unlike the synthetic image GAN 302, which may have a generator and a discriminator, the image refiner GAN 312 has a refiner network that generates realistic and refined synthetic images that can fool the discriminator and a discriminator network, which predicts the probability that the refined image is real or synthetic.

In embodiments of the disclosure, multi-dimensional data classification is performed using Artificial Intelligence processing. Various data curation tasks such as documentation, organization, and data integration from multiple scenarios and sensors, metadata creation, and/or annotation may be performed, as described more fully below. In embodiments, an instance number, class name, original raw name, and object attributes in the multi-dimensional data may be provided in standard JSON for classification training.

There are known neural networks based on multi-dimensional numbers that address interrelationship issues. Known complex-valued neural networks (CVNN) may address the multi-dimensional interrelationship preservation issue. However, these networks are limited to two dimensions (magnitude and phase).

In embodiments, processing includes quaternion and/or octonion neural networks to tackle real-world multidimensional data. Illustrative quaternion and/or octonion processing is shown and described in M. Gong, M. Zhang, and Y. Yuan, “Unsupervised band selection based on evolutionary multiobjective optimization for hyperspectral images,” IEEE Transactions on Geoscience and Remote Sensing, vol. 54, no. 1, pp. 544-557, 2015, H.-C. Li, C.-I. Chang, L. Wang, and Y. Li, “Constrained multiple band selection for hyperspectral imagery,” in 2016 IEEE International Geoscience and Remote Sensing Symposium (IGARSS), 2016, pp. 6149-6152: IEEE, M. K. Pal and A. Porwal, “Dimensionality reduction of hyperspectral data: band selection using curve fitting,” in Multispectral, Hyperspectral, and Ultraspectral Remote Sensing Technology, Techniques and Applications VI, 2016, vol. 9880, p. 98801 W: International Society for Optics and Photonics, A. Oliva and P. G. Schyns, “Coarse blobs or fine edges? Evidence that information diagnosticity changes the perception of complex visual stimuli,” Cognitive psychology, vol. 34, no. 1, pp. 72-107, 1997, and W. McIlhagga and K. T. Mullen, “Evidence for chromatic edge detectors in human vision using classification images,” Journal of vision, vol. 18, no. 9, pp. 8-8, 2018, all of which are incorporated by reference.

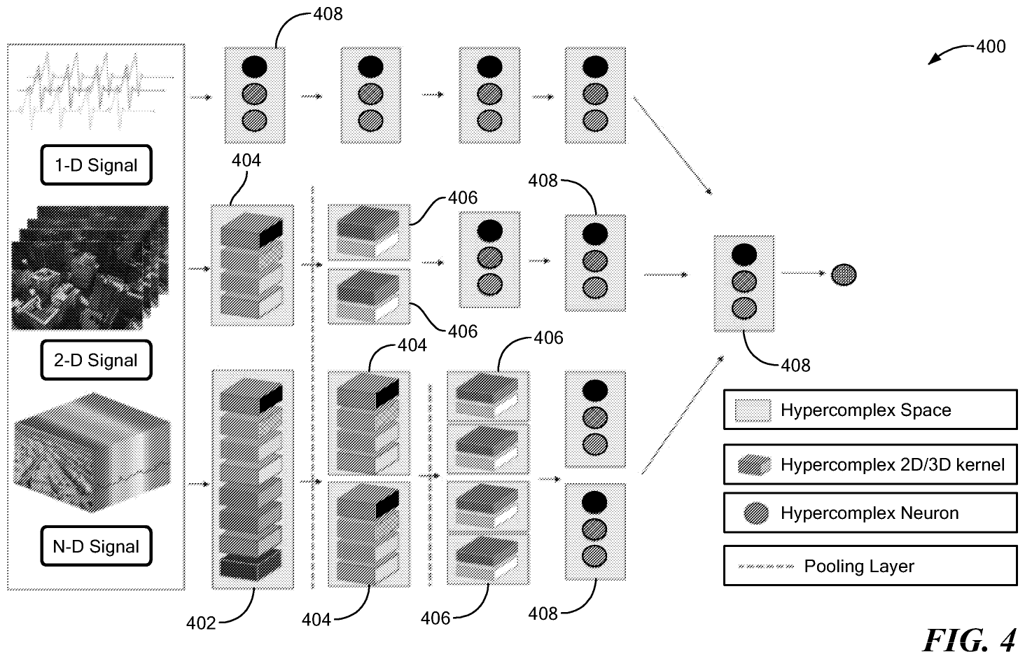

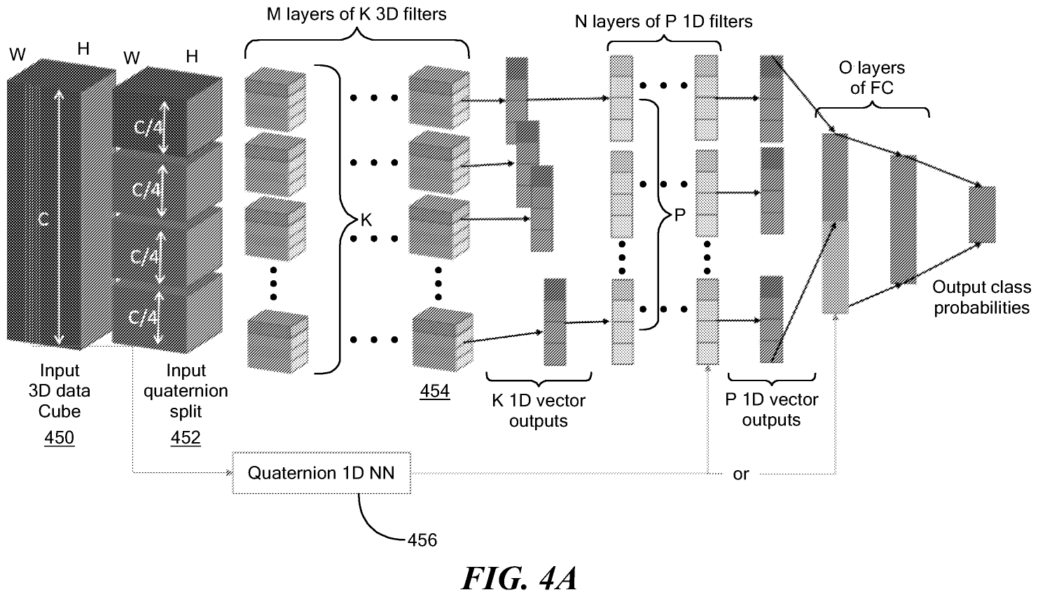

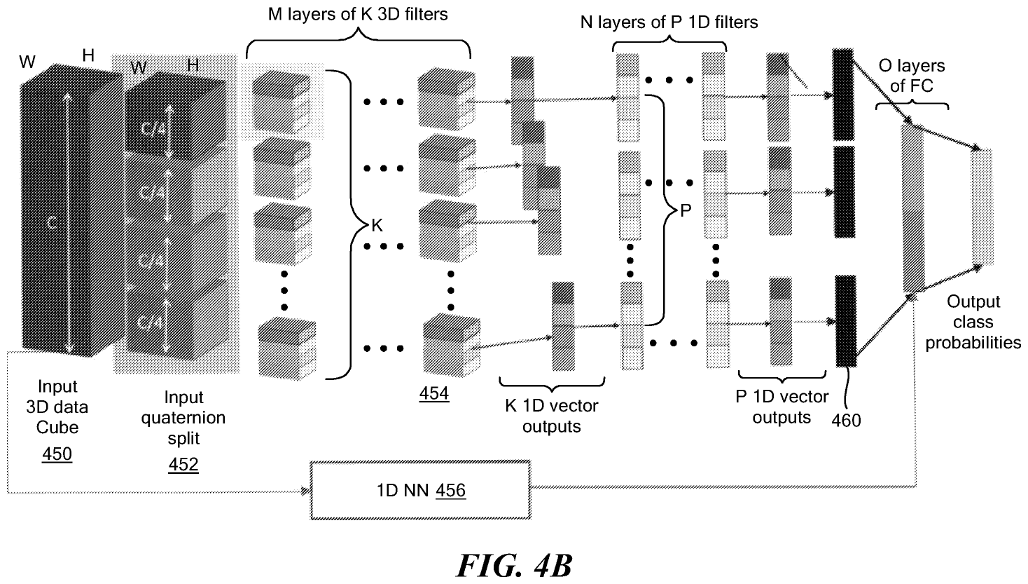

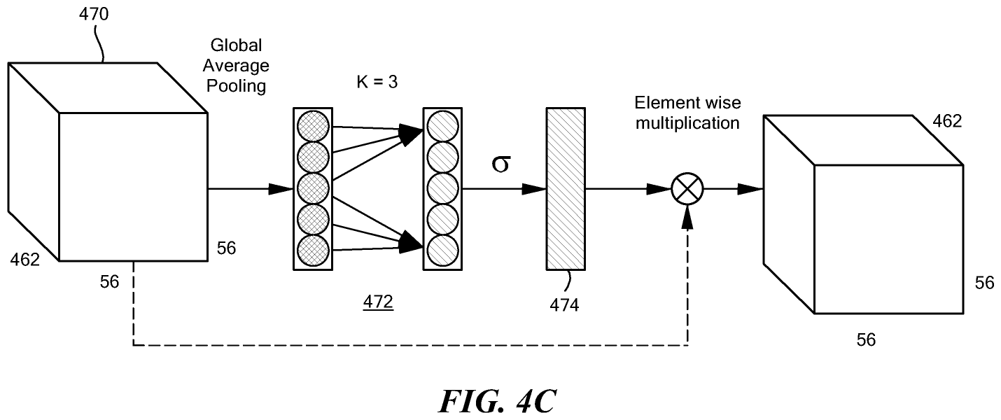

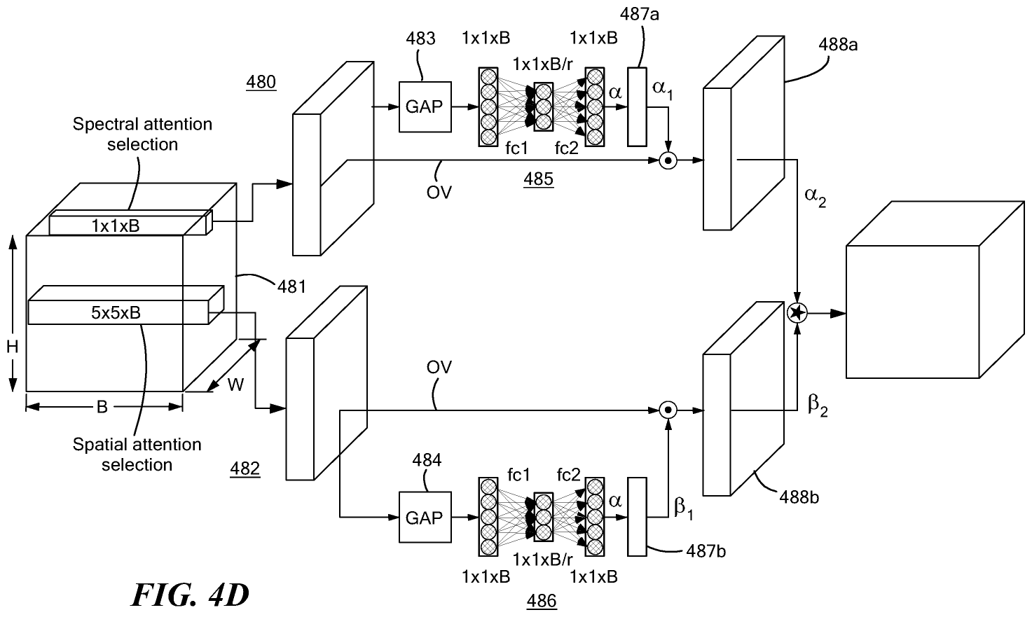

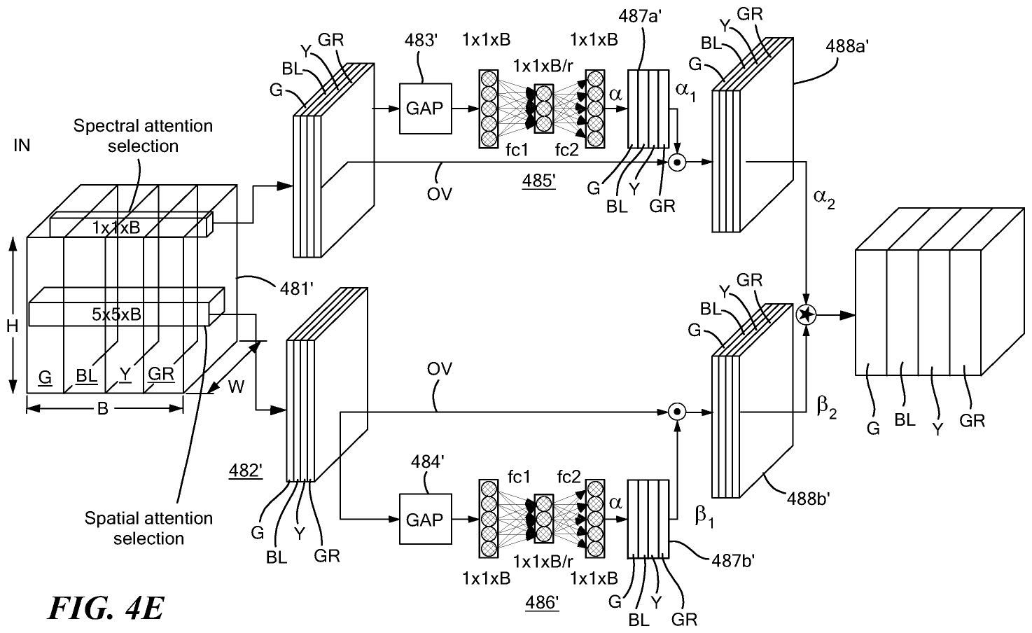

FIG. 4 shows an example system 400 having a mixed hypercomplex CNN with convolution, fully connected, and pooling layers. In embodiments, a hypercomplex-based neural network and task-specific loss functions are built upon multiple hypercomplex algebras and may include combinations of at least some of the hypercomplex algebras, such as sedenions, octonions, quaternions, complex, and traditional CNNs in a single architecture. For example, in one particular embodiment, multidimensional HS data can be divided into 16 sub-groups that can be fed to a single sedenion, two sets of octonions, four sets of quaternions, and/or eight sets of complex CNNs to extract features. The hypercomplex space can include any of these CNNs and conventional real-valued CNNs. Apart from the CNNs, the network may include pooling layers, such as max pool, average pool layers, activation functions, such as ReLU or its modifications, and hypercomplex-based fully connected layers. These pooling layers and activation functions may be configured to adapt to the hypercomplex space or their combinations. For example, performing max pool for quaternion space requires different considerations than real-valued max pool operations.

FIG. 4 shows an exemplary hypercomplex neural network system 400 that processes a multitude of data including, but not limited to, 1D signals, 2D signals, and N-D signals. The 1D signals, in some cases, include spectral signatures and information pertaining to environmental conditions such as light, color temperature, etc. The 2D signals, in some cases, might include grayscale or monochrome images, thermal images etc. The N-D signals, in some cases, might include RGB images (3D), hyperspectral images, multispectral images, etc. This exemplary system describes a neural network model which combines sedenions, octonions, quaternions, complex, and real-valued networks. In the illustrated embodiment, eight cubes signify octonions 402, four cubes signify quaternions 404, and two cubes signify complex networks 406, with the remainder real-valued networks 408.

For real-valued CNNs, numerous loss functions can be defined and used for different tasks. For example, cross-entropy, binary cross-entropy, and negative log-likelihood are defined in the classification case, while mean squared error (MSE) and absolute error is defined for image restoration tasks. In embodiments, a differentiable hypercomplex algebra-based loss function respects channel interrelation. For example, in the case of image restoration tasks that uses quaternion CNNs, the quaternion Mean Squared Error (MSE) loss function may be utilized to optimize the network. This error function will have four degrees of freedom and will preserve the physical meaning inherent to the quaternion domain.

It is understood that hypercomplex numbers generalize the notion of the well-known Cayley-Dickson algebras and real Clifford algebras and include whole numbers, complex numbers, dual numbers, hyperbolic numbers, quaternions, tessarines, and octonions as particular instances. Hypercomplex neural networks can process many kinds of information that may not be adequately captured by real-valued neural networks, such as phase, tensors, spinors, and multidimensional geometrical affine transformations. A hypercomplex number [symbol] can be represented as formulated in equation (1).

$$ℍ = \{ {h}_{0} + {h}_{1} {i}_{1} + {h}_{2} {i}_{2} + {h}_{3} {i}_{3} + … + {h}_{n} {i}_{n} \} \qquad ( 1 )$$

where n is a non-negative integer, h₀, h₁, . . . , hₙ are real numbers, and the symbols i₁, i₂, . . . , iₙ are called hyper imaginary units. The system of combining two hypercomplex representations [symbol] ₐ and [symbol] _{b}, each having a different number of imaginary components, in a single network is termed as mixed hypercomplex NN. In embodiments, neural networks use the complete set of hypercomplex algebra in a unified manner.

An example mixed hypercomplex-based NN may have input to the system that is task-dependent and can be N-dimensional data, e.g., n for 1D data, n×n for 2D, and n×n×n for 3D data. A series of mixed hypercomplex convolution, pooling, activation layers, and optional fully connected layers can be arranged in a certain pattern to obtain the output. This output can be 1D for image level classification and 2D for pixel level classification.

Consider the example of quaternions. The quaternion numbers are a part of the hyper-complex numbers constructed by adding two more imaginary units to complex numbers that include a scalar or real part q₀∈ [symbol] , a vector part \vec{q}=(q₁, q₂, q₃)∈ [symbol] ³ and i, j, and k are the standard orthonormal basis for [symbol] ³. Then a quaternion [symbol] within a set of hypercomplex denoted by [symbol] can be represented as:

$$ℚ = {q}_{0} + {q}_{1} i + {q}_{2} j + {q}_{3} k \vert q ∈ ℝ , \qquad ( 2 )$$

$${i}^{2} = {j}^{2} = {k}^{2} = iik = - 1$$

Quaternion representations are discussed, for example, in A. Grigoryan, S. Agaian, Quaternion and Octonion Color Image Processing with MATLAB, book, 5 Apr. 2018, which is incorporated herein by reference.

It can be deduced from the above expression that having q₂=q₃=0, equation (2) reduces from quaternion space to a complex-space valued and having q₁=q₂=q₃=0, reduces it to real-valued space. This enables quaternion space to represent 1D/2D and multi-dimensional data by using the reduced-hypercomplex and full-hypercomplex representations, respectively. A similar approach can be extended to other hypercomplex algebras.

Further, to understand the representation of HS data in the hypercomplex domain, consider the quaternion space representation of 2D data with three channels-n×n×3, for example, R, G, B. Each of the three channels can be associated with the three imaginary axes of the quaternion space and having either zeros or gray levels related to the real axis. Similarly, in the multidimensional case of HS imaging, the total number of bands or the depth of the HS data cube can be divided into four groups for quaternion processing, and each group can be associated with each of the axes of the quaternion domain.

An example approach for segregating the different hyperspectral data bands for quaternion space is shown and described in S. P. Rao, K. Panetta, and S. Agaian, “Quaternion based neural network for hyperspectral image classification,” in Mobile Multimedia Image Processing, Security, and Applications 2020, 2020, vol. 11399, p. 113990S: International Society for Optics and Photonics, which is incorporated herein by reference. In that approach, grouping was done based on the physical relevance and inter-relation of the various wavelengths/bands. Other techniques can also be used, such as bands correlation, spectral derivative analysis, graphs lambda λ₁ vs. lambda λ₂, band variance, and/or entropy. These techniques can be extended to other hypercomplex algebras and their combinations as well.

It is understood that the contiguous and narrow spectral bands in HSI have a strong inter-band correlation between them. In exemplary embodiments, maintaining this correlation while training a neural network may be desirable. 3D convolution may generate abundant network parameters leading to high computational burdens, and the design of 3D CNNs in real-valued networks instigate the loss of interrelation between the bands.

FIG. 4A shows an example Quaternion NN system for detecting defects in accordance with example embodiments of the disclosure. In the illustrative embodiment, input hyperspectral data 450 is split into four parts 452 and fed to a quaternion NN 454, which has M layers of K 3D filters, N layers of P 1D filters and O fully convolutional layers. Additionally, each hyperspectral image pixel is considered 1D signal 456 and applied to the FC layer.

The system can output a 1D vector of output class probabilities. It can be further modified to give per pixel classification, in which case the output will be an image of same W and H as the input hyperspectral data, with each pixel representing the class to which it belongs.

In some embodiments, the Quaternion NN will include transform domain filters such as Fourier domain or wavelet domain. The NN learns how to combine these transform domain filters rather than learning the filters themselves. In some other embodiments, the Quaternion NN is built using Fourier transform NN instead of convolutional NN.

FIG. 4B shows the Quaternion NN of FIG. 4A with the addition of a layer 460 to convert the features from quaternion space to real space.

In some embodiments, the hyperspectral data is considered as a stack of 1D signals and the 1D NN considers all the signals, while the multidimensional quaternion network considers only key bands and not the entire hyperspectral data cube. The selection of key bands may be implemented in an application specific manner. Example network embodiments improve the computational requirement of the network making it more suitable for resource constrained environments such as smart phones, edge devices, and the like.

FIG. 4C shows an illustrative embodiment of an example feature recalibration processing utilizing a spectral attention mechanism so that the features in the subsequent layers of the architectures can be re-calibrated based on the attention mechanism.

In the illustrated embodiment, a global average pooling (GAP) module 470 output is processed with a number (K) of filters 472 for a 1D convolution layer. The number K of filters can be selected based on a number of factors, such as spectral overlap between the channels, spectral redundancy, as well exploiting the spectral correlation of adjacent bands. As an illustrative example, a filter size of K=3 is used. σ indicates an input reshaping or range fitting function 474. In one particular embodiment, a sigmoid function is used governed by the following equation Sigmoid(x)=1/1+exp(−x). In the illustrated embodiment, the input reshaping/range fitting module 474 has an output that can be combined, such as by element-wise multiplication, with an input of the GAP module 470.

FIG. 4D shows an example parametric spatial-spectral attention mechanism that may be used for feature recalibration. In the illustrated embodiment, a spectral attention selection 480 includes a 1×1×B selection from a W×H×B input 481 and a spatial attention selection 482 of R×S×B. In this illustrative example, R and S are selected to be 5. The constraints on R and S include 1≤R≤W, and 1≤S≤H. For both selections 480,482, a respective pooling operation 483,484 is performed to reduce the dimensions along the spectral and/or spatial component.

As an illustrative example, the global average pooling (GAP) layer is used. It is understood that any suitable pooling mechanism can be used. Outputs of the pooling operations are passed through a respective series of fully connected (fc) layers 485, 486. In the illustrated embodiment, the global average pooling (GAP) result is passed through two fully connected layers with a reduction factor. The reduction factor governs the amount of reduction in neurons and has the following constraints 0<r≤B. The outputs from the fc layers 485,486 are then passed through a range-fitting module 487a,b. Example range fitting can comprise a sigmoid function governed by the following equation Sigmoid(x)=1/1+exp(−x). The respective outputs from the range fitting modules 487a,b are then combined with the original value OV with the help of a parametrized (α1, β1) operation denoted by ⊙. Illustrative examples of operation ⊙ includes but not limited to element-wise multiplication, parametric logarithmic image processing (PLIP) based multiplication. The outputs from the processing of the spectral and spatial selections 480,482 are merged through another parametrized (α2, β2) operation denoted by [symbol] . Illustrative examples of operation [symbol] include but are not limited to addition, max operator, min operator, PLIP addition. In some embodiments, these parameter values are selected based on experimental values and/or based on dataset(s). It can also be selected by using a neural network algorithm.

FIG. 4E shows an example quaternion parametric spatial and spectral attention network which can be considered a quaternion implementation of the system of FIG. 4D, where like reference numbers indicate like elements. The input IN and the various convolution layers comprise hypercomplex numbers, operators, and layers. In this illustrative example, after splitting the input IN into 4 parts of the quaternion (highlighted by gray G, blue BL, yellow Y, and green GR), the spatial 482′ and spectral 480′ selection is performed the output of which is then passed through the pooling GAP modules 483′, 484′ and FC layers 485′, 486′ which are quaternion in nature. After range-fitting 487a′,b′ and combining with the original value OV, the output is used as the parametrized multiplier value to recalibrate the incoming spectral or spatial features. A parametrized [symbol] function combines the results from the spectral 481′ and the spatial 482′ processing.

The advantage of quaternion and/or hypercomplex attention is in the ability of the quaternion operator to exploit the interwoven cross-channel relationships between the bands of the hyperspectral image. This in combination with the FC layers acts as a powerful extractor of band specific information that can boost the recalibration by suppressing noise while enhancing the content that contributes the most to the final result. Furthermore, the parametrized nature of the ⊙, [symbol] operators allows the network to learn and weight the calibration features based on their contribution to the final outcome.

In some embodiments, hyperspectral images may be masked using a region of interest mask to eliminate additional data points. In some embodiments, the hyperspectral data is preprocessed utilizing decompositions such as wavelet, pyramidal, quaternion pyramidal, and quaternion pyramidal using parametric logarithmic image processing (PLIP). Example PLIP processing is shown and described in U.S. Pat. No. 9,299,130, the contents of which are incorporated herein by reference.

FIG. 4F shows example graphical representations of hyperspectral image perceived as a series of 1D signals. When looking at these signals in the illustrated plots, one can view them as 3136 1D signals each having 422 data points, or 422 1D signals each having 3136 data points. After passing through the 1D NN, these two systems collapse to data points being projected either on x-axis or y-axis, as shown. This has profound implications since, for example, the number of parameters remains constant in the second case (420 1D signals), while the parameters are image size-dependent in the first case.

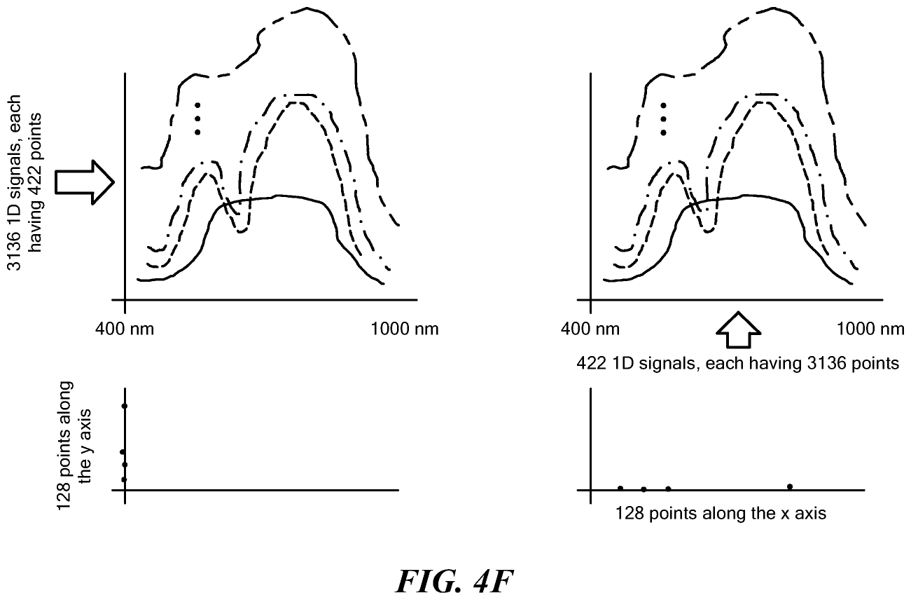

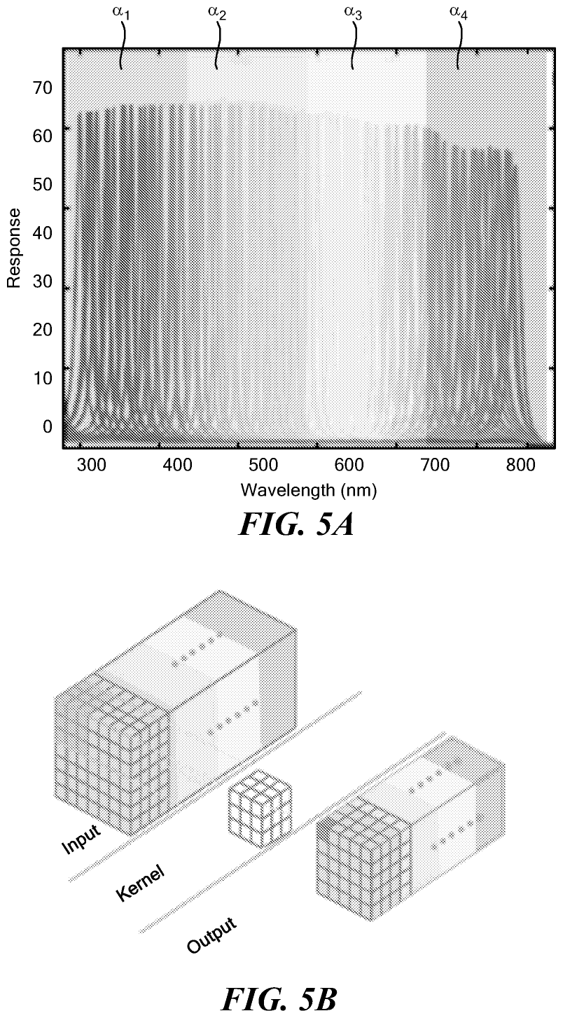

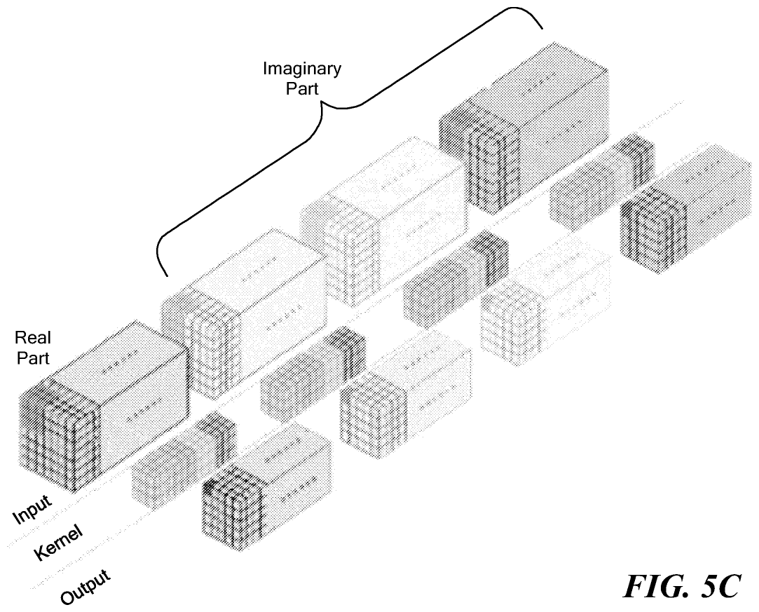

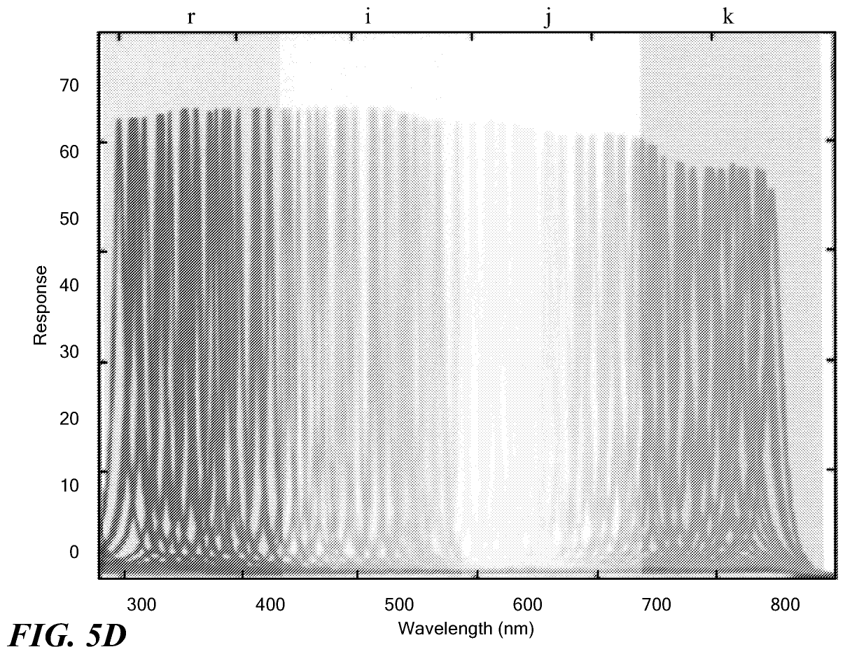

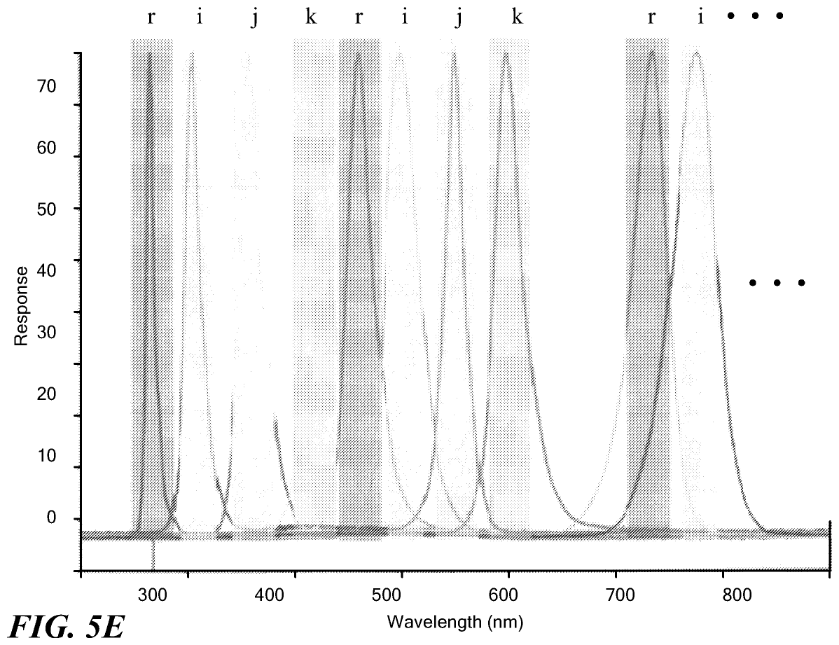

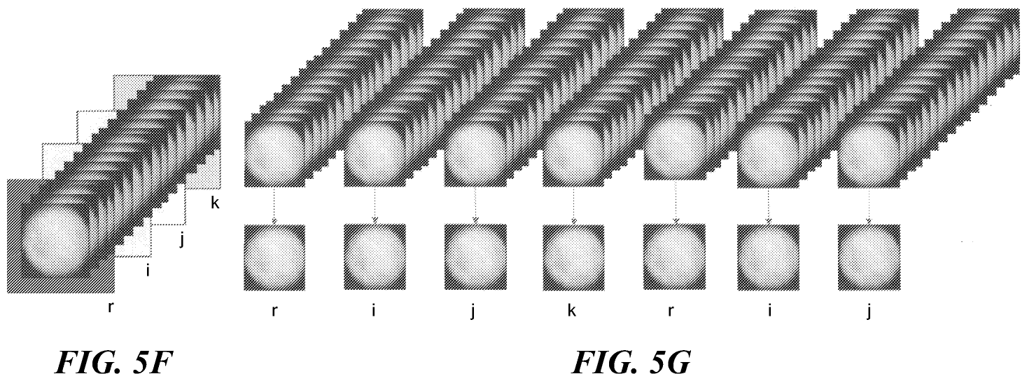

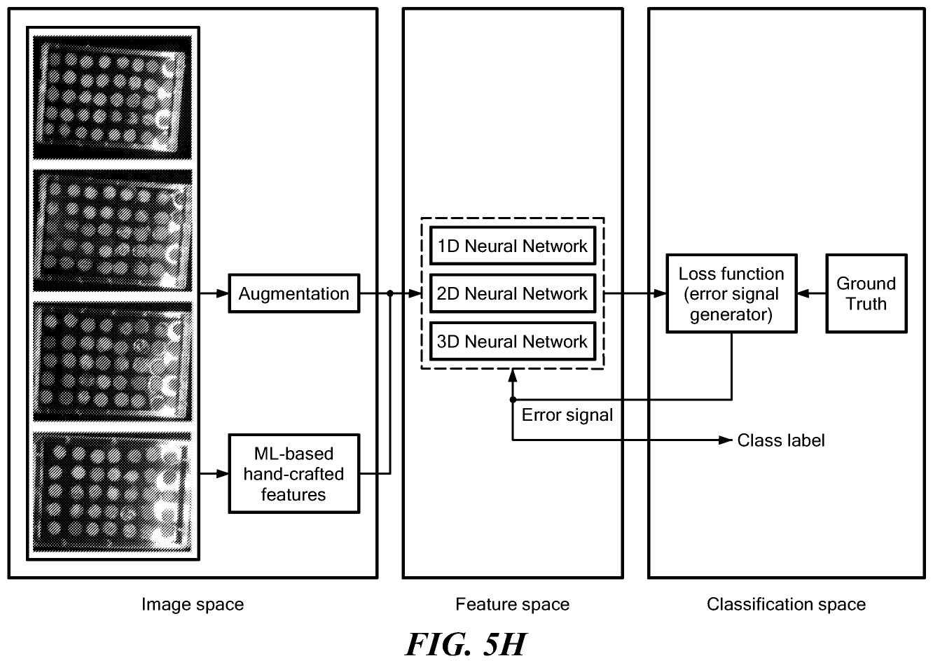

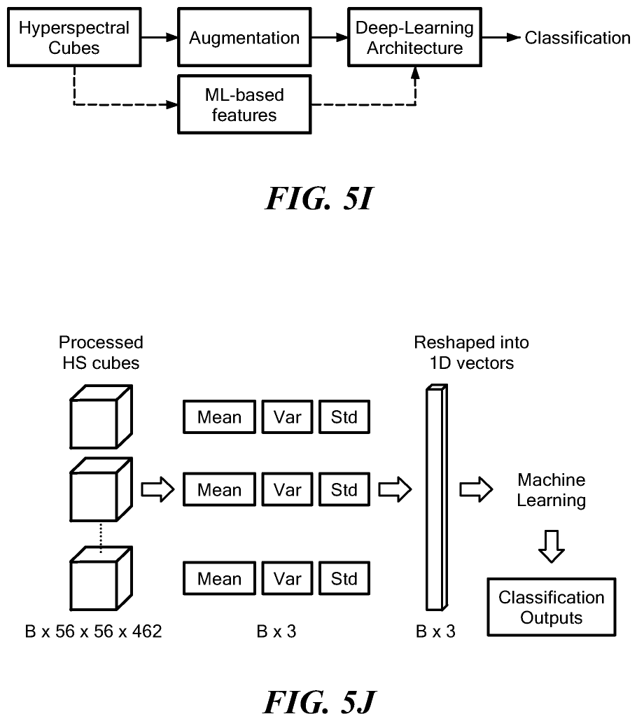

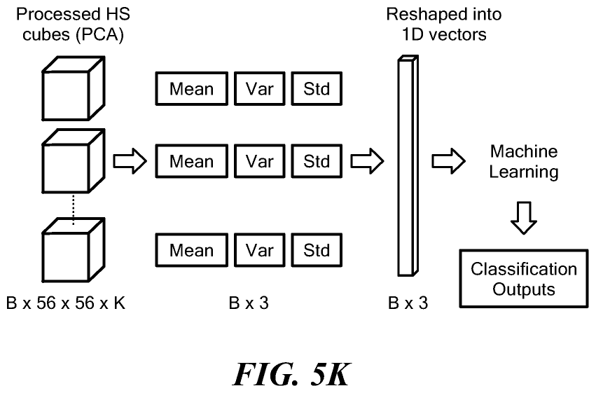

FIGS. 5A-5C show an example of the interrelationship preservation property of 3D CNN hypercomplex space algebras when compared to traditional 3D CNN. FIG. 5A shows an example of hyperspectral data divided into four segments α₁=α₄ that are provided as input to the system. As shown in FIG. 5B, a traditional 3D CNN utilizes a 3D kernel and feature maps that are essentially the weighted sum of the input features located roughly in the same output pixel location on the input layer. FIG. 5D shows a hypercomplex CNN producing feature maps for each axis using a unique linear combination of 3D kernels with the data from all the axes, thereby forcing each axis of the kernel to interact with each axis of the 3D data. This is beneficial for maintaining inter-band relations and achieving efficient and accurate HS data processing.

3D CNNs are an extension of the 2D convolution but with an advantage of a 3D filter that can move in three directions. Since the filter slides through the 3D space, the output is also arranged in a 3D space. Consider an HS cube divided into four segments-α₁-α₄ 3D CNN generates a lower-level 3D data in which the segment correlation is not completely exploited, but rather some relationship between adjacent bands is retained depending on the filter depth. However, in a hypercomplex based 3D CNN, the 3D kernel from each axis is combined in a unique way to produce the result. This enables each axis of 3D kernel to interact with each axis of the 3D HS data, thereby maintaining the relationship between adjacent and farther bands. Due to this feature of maintaining interrelationships between the channels, MDHNN can achieve better scaling and input rotation and provides a more structurally accurate representation of the band inter-relationships than conventional techniques. This feature also aids in making the neural network more robust to rotational variance. Furthermore, MDHNN can substantially reduce the number of parameters due to hypercomplex algebra structure.

It is understood that there are a variety of ways in which the quaternions can be generated from hyperspectral images. For example, as shown in FIG. 5D, all the bands of the hyperspectral image are divided into four groups r, i, j, k of the quaternion. FIG. 5E shows groups of four consecutive bands as quaternions. FIG. 5F shows the bands clumped into groups of four and four consecutive groups considered as the four parts of the quaternion. FIG. 5G shows sixteen bands fused into one image and four such images considered as the four parts of the quaternion. The fusion of the sixteen bands can be done by averaging, Gaussian weighted average, PLIP fusion, and/or any suitable technique.

It is understood that other image data division and band configuration will be readily apparent to one of ordinary skill in the art.

In some embodiments, hypercomplex networks can comprise binary networks, with either the weights being binary, or the images being binary, or both the hyperspectral images and weights being binary. Binary NNs increase speed with models being to run in resource constrained environments, such as smart phones, edge devices, etc.

FIG. 5H shows a high-level implementation of a system having machine-learning hand-crafted features in an image space to increase the quality of output classification. HS features are the unique characteristics that identify an HSI. To classify images, hand-crafted characteristics are extracted in example embodiments. Deep learning algorithms can automatically learn features in order to improve classification accuracy using a sophisticated network design and a sizable amount of computation time are typically needed. HS classification may be performed mostly using particular handmade features with a particular classifier and frequently produces good results. In order to take advantage of both methods, the hand-crafted HS features are incorporated into the Deep-learning models described above. This reduces the dependency on deep-learning algorithms to identify known HS features, and instead allows the deep-learning algorithm to concentrate on learning other effective HS features. Example methods have been proposed in the field of RGB 2D and 3D classification in, for example, P.-H. Hsu and Z.-Y. Zhuang, “Incorporating handcrafted features into deep learning for point cloud classification,” Remote Sensing, vol. 12, no. 22, p. 3713, 2020, D. Thakur and S. Biswas, “Feature fusion using deep learning for smartphone-based human activity recognition,” International Journal of Information Technology, vol. 13, no. 4, pp. 1615-1624, 2021, K. Shankar and E. Perumal, “A novel hand-crafted with deep learning features based fusion model for COVID-19 diagnosis and classification using chest X-ray images,” Complex & Intelligent Systems, vol. 7, no. 3, pp. 1277-1293, 2021, and T. Majtner, S. Yildirim-Yayilgan, and J. Y. Hardeberg, “Combining deep learning and hand-crafted features for skin lesion classification,” in 2016 Sixth International Conference on Image Processing Theory, Tools and Applications (IPTA), 2016, pp. 1-6: IEEE, all of which are incorporated herein by reference.

The illustrative system 500 of FIG. 5H includes an image space 502, a feature space 504, and a classification space 506. Image input in the image space 502 is provided to an augmentation module 510 and to an ML-based hand-crafted features module 512, the outputs of which are combined and provided to a NN layer 514. In the illustrated embodiment, the NN layer 514 comprises a 1D neural network 516, a 2D neural network 518, a 3D neural network 518. The classification space 506 includes a loss function 520 that generates an error signal for the NN layer 514. A ground truth module 522 provides information to the loss function module 520 for generating the error signal. FIG. 5I shows a simplified version of ML-based features and conventional HS cubes.

Some Machine-Learning (ML) based hand-crafted HS features may be used in combination with the neural networks described above and may include the mean, variance, and standard deviation of each hyperspectral cube as shown in FIG. 5J. It is understood that B×56×56×462=Batch×width×height×channels. In some cases, it could be the mean, variance, and standard deviation of the principal component analysis of each hyperspectral cube, as shown in FIG. 5K. FIG. 5L shows a combination of the approaches described above.

Hand-crafted HS features can also be extracted using, for example, Histogram of oriented gradients (HOG), Scale Invariant Feature Transform (SIFT), speeded up robust features (SURF), Local Binary Patterns (LBP), Extended Local Binary Patterns (ELBP), Fibonacci LBP,
and Gabor. Example Fibonacci extraction is disclosed in K. Panetta, F. Sanghavi, S. Agaian and N. Madan, “Automated Detection of COVID-19 Cases on Radiographs using Shape-Dependent Fibonacci-p Patterns,” in IEEE Journal of Biomedical and Health Informatics, vol. 25, no. 6, pp. 1852-1863 June 2021, doi: 10.1109/JBHI.2021.3069798, which is incorporated herein by reference. In some cases, it could be a combination of the abovementioned features.

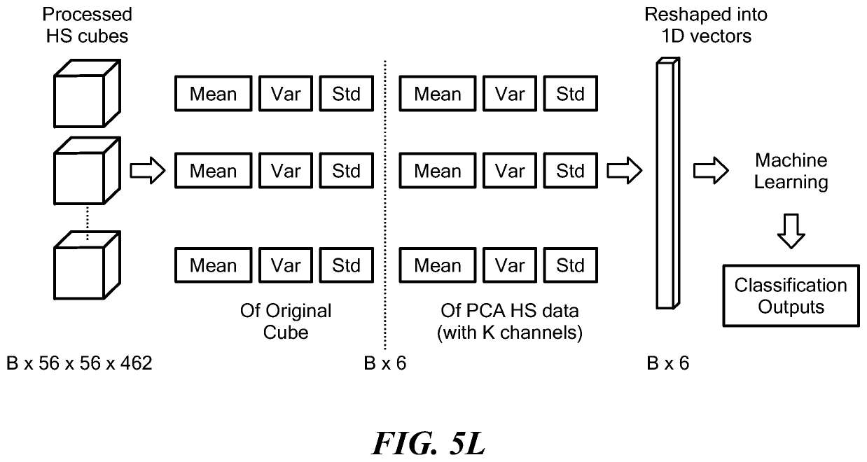

FIGS. 6A-6C show experimental results for classification under varying lighting conditions according to an exemplary embodiment of the preset disclosure. FIG. 6A shows an image having real and fake items and FIG. 6B shows the ground truth for the image of FIG. 6A. FIG. 6C shows four different lighting conditions varying from 2500 to 6500 Kelvin where the left image in each lighting category represents the per-pixel classification map and the accuracy for quaternion-based processing, and the right image is for octonion deep learning-based networks. As can be seen, the octonion network (the right images) has better resilience to lighting variations when compared to quaternion processing. These hypercomplex networks are capable of extracting the inter-band correlations more efficiently than conventional networks.

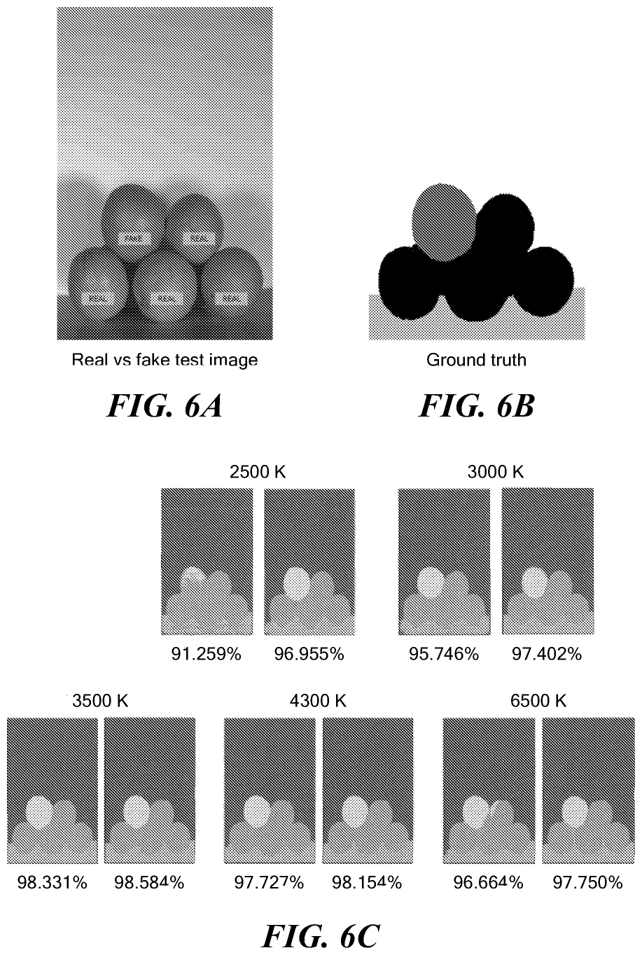

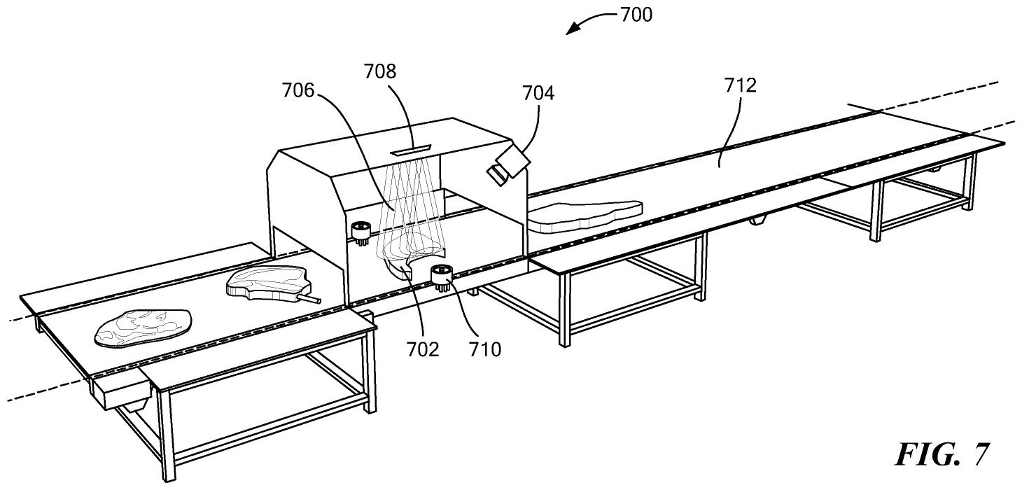

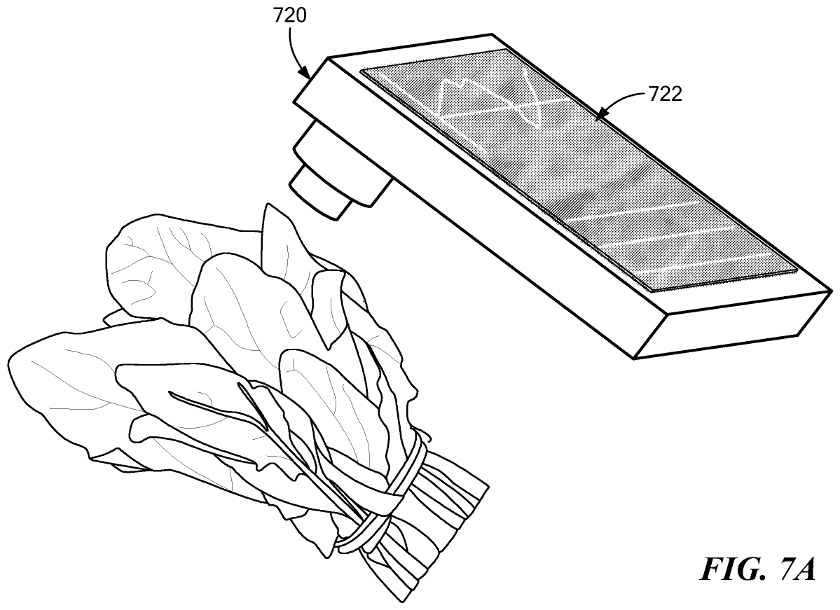

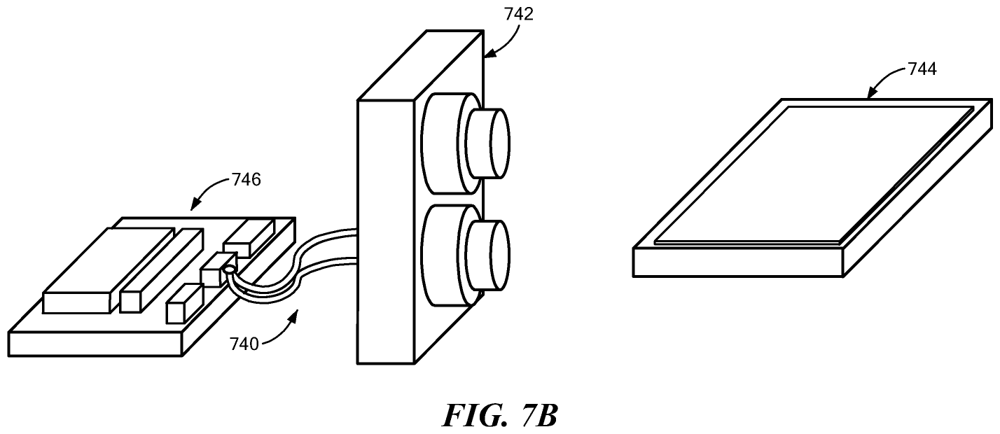

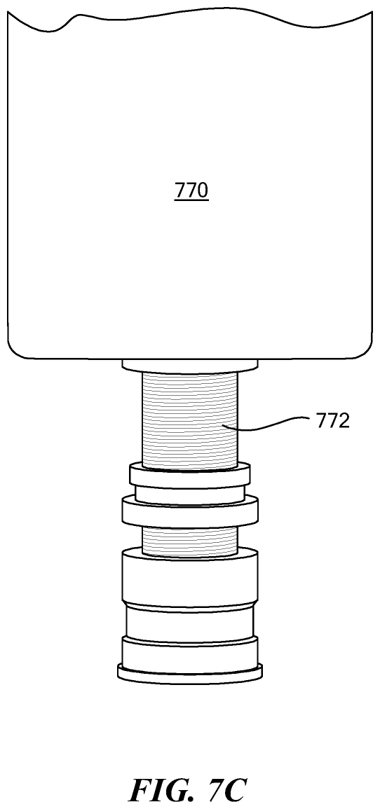

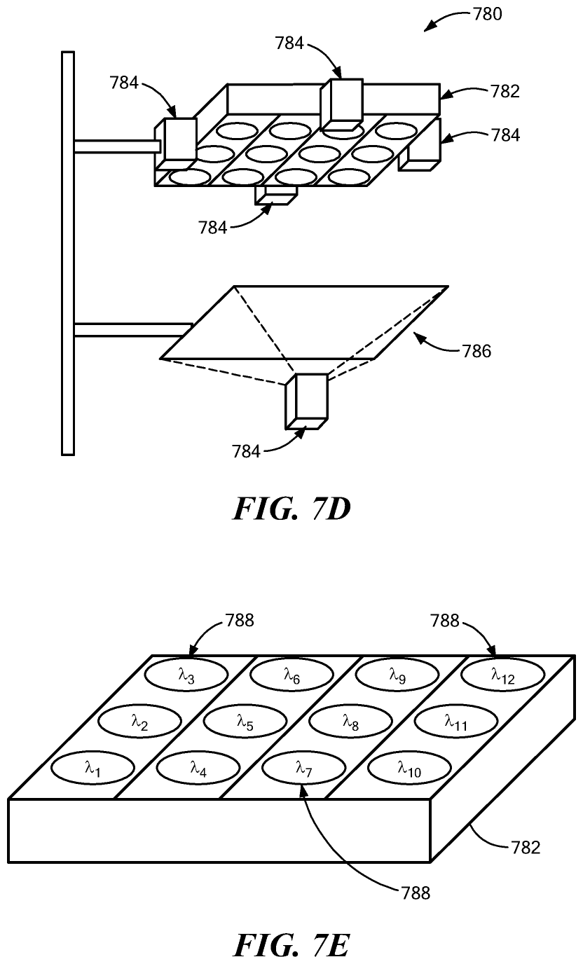

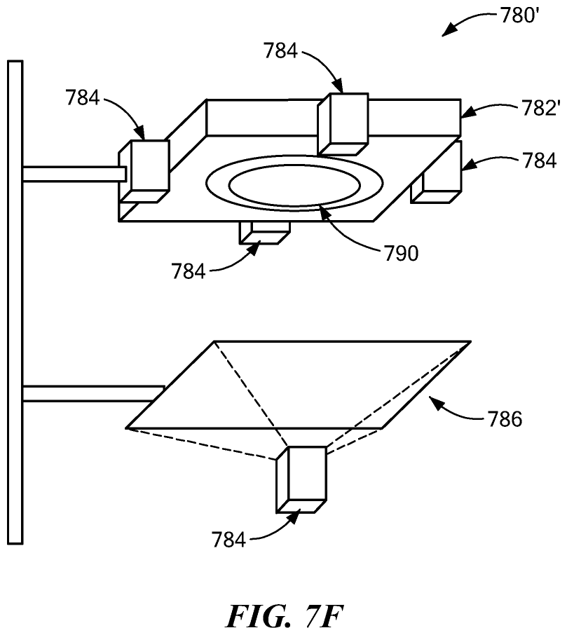

FIG. 7 shows an example stationary inspection system 700 for detecting defects, such as pathogens, in sample 702, such as a food portion. System 700 includes an imaging sensor 704 with a field of view (FOV) that includes the food sample 702 in an inspection area 706. At least one illumination source 708 illuminates sample 702 to a desired luminance level. A color temperature sensor and light sensor 710 can measure color temperature and luminance level of the sample. In the illustrated embodiment, a conveyor belt 712 can move samples in and out of the inspection area 706. With this configuration, the samples do not need to be prepared and the system is automated and non-invasive. The system can rapidly acquire images of the samples to keep pace with selected processing speeds. In addition, the system enables visualization of the spatial distribution of parameters for the samples.

It is understood that any practical imager can be used to meet the needs of a particular application. Imagers can comprise line scan hyperspectral imagers for capturing images from about 400 nm to 1000 nm or more with 300 or more spectral images, reduced spectrum imagers ranging from about 1-N, where N is the number of spectral images, limited spectrum imagers, and RGB imagers that capture images in the visible range of about 400 nm to about 700 nm, and thermal imagers.

It is understood that inspection systems can be implemented in a wide range of configurations with various components to meet the needs of a particular application. For example, FIG. 7A shows an inspection device 720 having an attached hand-held microscope 722. The device 720, which is portable, can include multi-dimensional image processing using the images from the microscope 722. As described above, RGB images can be converted by the device to multi-dimensional processing for AI analysis to detect defects. FIG. 7B shows an inspection system 740 having an embedded camera 742 and display 744, such as an LCD display. An attached circuit board 746 can include a processor, such as an NVIDAI AI processor, for real-time defect detection and visualization.

FIG. 7C shows an example imaging device 770 having an extension tube 772 to enhance the capture of spatial information. In some embodiments, the imaging device 770 can include one or more lenses configured to block certain wavelengths to achieve image capture only in the intended wavelength range. For example, UV filters can be used so that no UV light passes through when capturing Visible+Near Infrared light.

A hyperspectral camera can capture UV (200-400 nm), Visible (380-800 nm), NIR (900-1700 nm), MWIR (3-5 um), LWIR (8-12 um). It is understood that a range of lighting system configurations can be used according to a range of wavelengths. Example lighting combinations for the Visible-Near Infrared range, e.g., about 400-1000 nm could include the following:
Visible+Near Infrared (400-1000 nm)
Visible+Near Infrared (400-1000 nm)+UV (<400 nm)
Visible+Near Infrared (400-1000 nm)+Mid IR (1000 nm-2500 nm)
Visible+Near Infrared (400-1000 nm)+IR (>2500 nm)

It is understood that any useful combination of wavelength ranges can be used to meet the needs of a particular application.

FIG. 7D shows an example imaging system 780, including a hyperspectral array imager 782 and a series of light sources 784 to illuminate an inspection area. A clear base tray 786, for example, allows light to pass through. FIG. 7E shows an example hyperspectral array imager 782, including an array of the unique wavelength filter lens 788. Within the array of lens stacks 788, each lens creates an optical channel that forms an image of the scene on an array of light-sensitive pixels. In embodiments, the lens stacks 788 are configured so that pixels from each lens sample the same object space or region within the scene. In some embodiments, the wavelengths selected for each lens will be application dependent.

FIG. 7F shows an example imaging system 780′ having similarity to the system 780 of FIG. 7D with the addition of a lens 790 positioned in relation to the hyperspectral array imager 782.

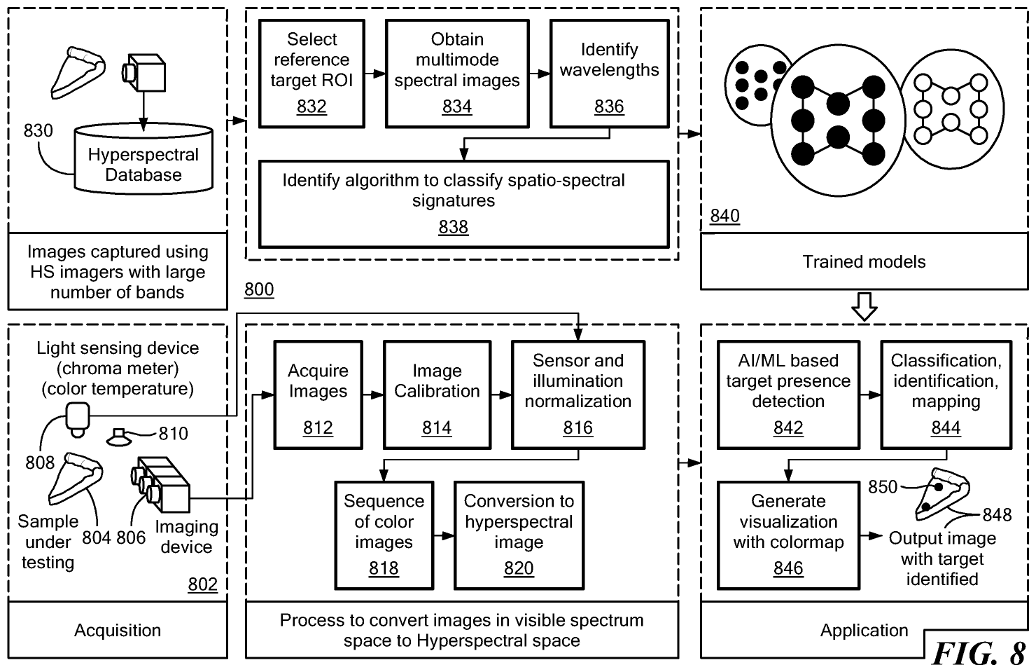

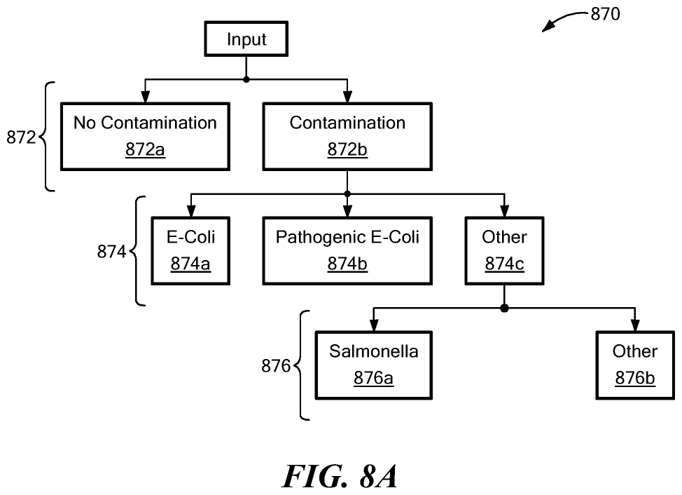

FIG. 8 shows a block diagram of an example inspection system 800 that detects defects in samples using multi-dimensional imaging and AI analysis in accordance with example embodiments of the disclosure. The system 800 includes an inspection area 802 for one or more samples 804. An imaging device 806 captures images of the sample and a light sensor device 808 obtains color temperature information, for example. One or more light sources 810 can be used to illuminate the sample to desired luminance levels.

Example pseudocode for image acquisition and image preprocessing is set forth below:
Ensure the inspection area is illuminated either by one or more light sources or sunlight
Ensure the sample is in the field of view of the imaging device
Collect the ambient environmental data such as color temperature
Acquire and calibrate the images for lens distortion, radiometric and geometric calibration
Normalize the image utilizing the ambient environmental information
Convert to a sequence of images
If acquiring device is not hyperspectral, then convert the images to hyperspectral image

The system performs processing to acquire image 812 and calibrate image 814. Based on the information from the light sensor 808, the images can be processed to be normalized 816 using the luminance level and/or sensor characteristics. In embodiments, the measured spectral data is modified to match the color temperature and the luminance of the trained model based on adaptive color and luminance normalization. The system 800 can perform processing so that the images can be sequenced 818 and, if necessary, such as if the imaging device is not hyperspectral, the images can be converted to hyperspectral images 820 prior to detection and classification. A conversion module can perform any or all of the processing in blocks 812-820.

Example pseudocode for defect detection is set forth below:
Create and curate hyperspectral image dataset
Train AI system
Acquire, calibrate, normalize images of the sample with ambient environment information
If the image is not hyperspectral, convert it to hyperspectral
Detect the presence of defects utilizing AI/ML
Visualize the defect

The system 800 can include an image database 830, which may contain multi-dimensional images of various types of samples. The images can include some number of frequency bands. Example pseudocode for hyperspectral database creation and curation is set forth below:
Create a database of hyperspectral images with the required defect present in it
Annotate the dataset by marking the areas with the defect (manual labeling or computer-implemented)
Create multimode spectral images by utilizing other imaging modalities such as color/thermal images
Identify key wavelengths empirically or utilize AI techniques
Identify algorithms for classification task

Based on the sample type, for example, the system 800 can perform processing to select a region of interest (ROI) for a reference target 832. Reference target selection may include processing to select an ROI in the captured images. The ROI refers to places in the image where it is known that pathogens are present. In embodiments, ROI areas are marked by drawing a bounding box around them. The selection maybe performed manually or by a computer-implemented algorithm (e.g., a computer processor carrying out instructions encoded on a computer-readable medium). Multimode spectral images can be obtained 834 based on the sample to enable the system to perform processing for identifying a set of wavelengths 836. In embodiments, identifying a set of wavelengths 836 may include considering the multiple spectrums obtained from the multi-dimensional image and attempting to identify a particular pattern in a specific wavelength in a specific region of interest. For example, E-coli are prominently found in 491 nm, 497 nm, 505 nm, 509 nm, 565 nm, 572 nm, and 602 nm spectrums. In example embodiments, the system tries to determine the most prominent wavelength for a given pathogen in an image. Based on the set of wavelengths, processing can be performed to identify processing techniques to classify the spatio-spectral signatures of sample 838. Once the set(s) of wavelengths is identified, a neural network can check for a specific pattern in these wavelengths to determine if a defect, such as E-coli on spinach, is present in the captured image. If present, a high probability score for the defect may be output. An AI module 840 can comprise one or more trained AI models to process the data to perform artificial intelligence/machine learning processing 842 to detect defects in the sample. After detecting a defect, the system can perform processing to classify, identify, and/or map 844, which can be used to generate a visualization 846 of defect 850, such as a color map. A visualization module can perform the processing to generate the visualization 846. An analysis module can perform the artificial intelligence/machine learning processing 842 and/or the processing to classify, identify, and/or map 844 the defect. The image can be generated and output 848 with an identified defect 850 or target, such as a pathogen.

Example pseudocode for AI training and visualization is set forth below:
Utilize hyperspectral curated dataset and Key wavelength to generate the ground truth for AI algorithms
Train the AI with multimode spectral images and the generated ground truth data
Detect the presence of the defect
Classify/Identify/Map the defect
Create human consumable visualizations

In example embodiments, image calibration processing 814 provides a pixel-to-real-distance conversion factor that allows image scaling to metric units. This information can be then used throughout the analysis to convert pixel measurements performed on the image to their corresponding values in the real world. Image calibration 814 may also allow mismatch correction in the images. For example, when images from two sensors are captured, each sensor might have different field of view and might capture varying amount of information. Image calibration 814 may resolve this by performing registration to make sure the same content is used from different images

Image normalization processing 816 may take the calibrated image along with the light sensing devices as input and ensure the system illumination is constant across all conditions. For example, the images taken under different lighting conditions will exhibit different characteristics, as shown and described above. Image normalization processing 816 enables the system to correct these non-uniform illumination artifacts.

In some embodiments, non-multi-dimensional imagers may be used. Multi-dimensional image conversion processing 820 may use AI, for example, to convert multi-band images, e.g., images taken in the visible plus Near-Infrared spectrum, into hyperspectral images. This approximation enhances pathogen content prediction as compared to only RGB channels or heat signatures.

In example embodiments, artificial intelligence/machine learning to detect defects may include a trained neural network model which considers images from different sensors, for example, the RGB, heat signatures and/or hyperspectral images to provide a probability of a pathogen content. This can provide classification scores to improve pathogen diagnosis.

FIG. 8A shows an example classification hierarchy 870 for defects in a food sample. Instead of handling all classification with one NN model, classification is split based on the example hierarchy. Splitting classification may improve the accuracy of the system. In some embodiments, each of the NN models can be hypercomplex including real, complex, quaternion, and/or octonion. In embodiments, where is one NN for each level of the hierarchy.

In the illustrated embodiment, a first hierarchy level 872 includes a no contamination block 872a and a contamination block 872b. A second hierarchy level 874, which is below the contamination block 872b, includes an E-coli block 874a, a pathogenic E-coli block 872b, and another block 872c. A third hierarchy level 876, which is below the other block 872c, includes salmonella 876a and other 876c.

It is understood that any practical number of NNs and hierarchy elements and structures can be used to meet the needs of a particular application.

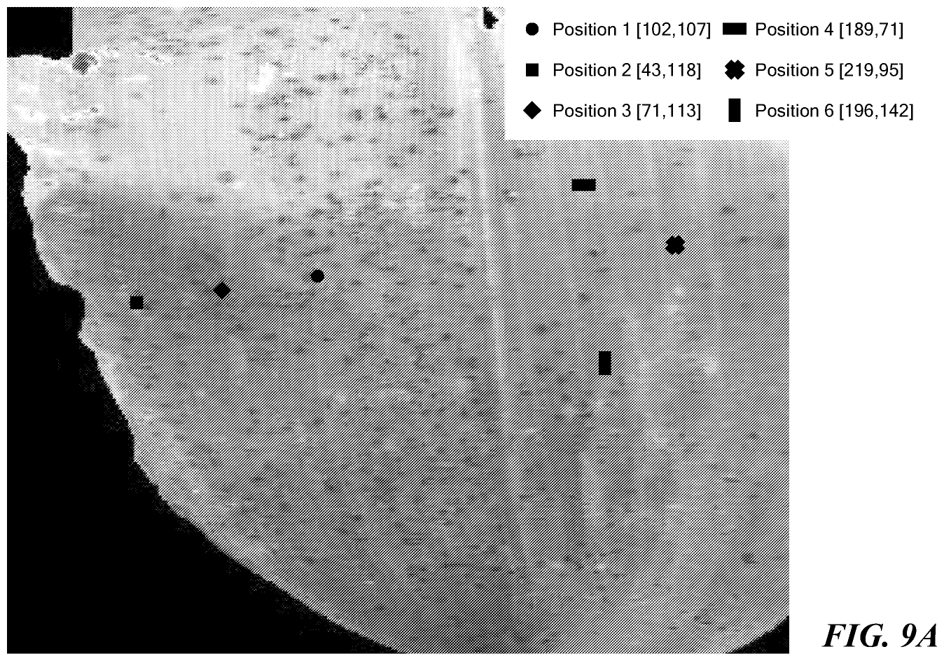

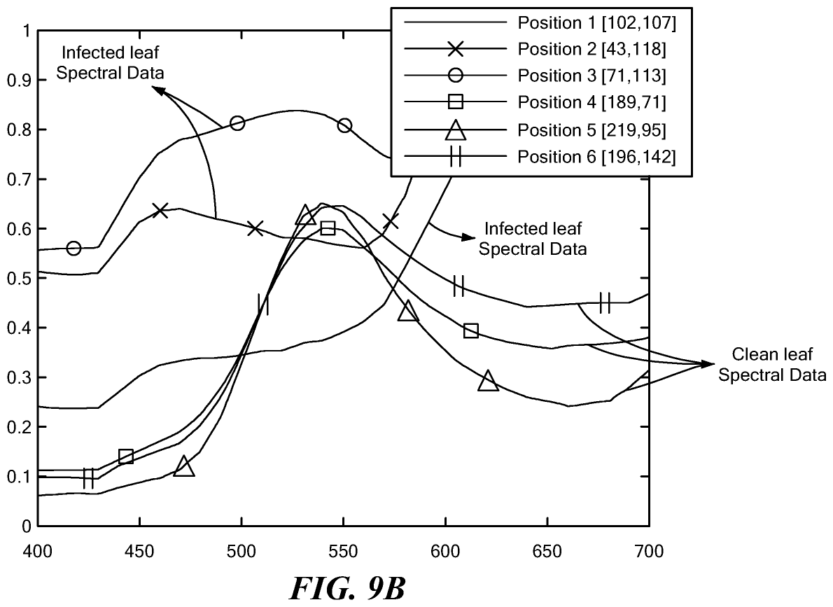

FIG. 9A shows an image of a corn leaf with rust pixels at positions 1 to position 6 and FIG. 9B shows the spectrum data for the leaf of FIG. 9A. The spectrum corresponds to the RGB spectrum of visible light from about 400 nm to about 700 nm. As can be seen in FIG. 9B, infected leaf spectra is found at positions 1, 2, and 3, which can be considered regions of interest. Clean leaf spectral data is found at positions 4-6. The infected lead spectral data and the clean leaf spectral data correspond to respective wavelength patterns. In embodiments, an AI module can determine if a corn leaf sample's rust wavelength pattern is present.

In some embodiments, the range of HS datasets collected goes beyond a regular VNIR (400-1000 nm) range to includes a range of Hyperspectral wavelengths in the IR range (400-1700 nm). In embodiments, IR datasets can facilitate the classification of both abiotic, e.g., stainless steel, and biotic surfaces. Abiotic refer to being physical rather than biological, i.e., it is not derived from living organisms. Biotics relate to or result from living things, especially their ecological relations.

It is understood that various protocols can be used to generate samples for datasets to meet the needs of a particular application. Example protocols for the generation of spinach samples contaminated with E. coli to be captured via hyperspectral imaging for the purpose of training deep learning algorithms to detect and quantify E. coli on the spinach surface are described below.

### Spinach Inoculation

This protocol aims to generate a large amount (800-2,000 samples of each class) of spinach samples that resemble contaminated spinach in a factory setting. Cells are resuspended in sterile DI water instead of LB or PBS to avoid confounding spectral properties and the introduction of factors that may change cell morphology or metabolism. Inoculated spinach samples are stored for 48 hours at 6° C. to replicate spinach storage conditions. This protocol is adapted from Siripatrawan, U., Y. Makino, Y. Kawagoe, and S. Oshita. “Rapid detection of Escherichia coli contamination in packaged fresh spinach using hyperspectral imaging.” Talanta 85, no. 1 (2011): 276-281, which is incorporated herein by reference. Initial goals include differentiating between ETEC (Enterotoxigenic Escherichia coli (E. coli) and ECN (Escherichia coli Nissle) 1917 spectra and determining the limit of detection of the system.
1. Set 12.5 mL overnight cultures of ETEC and ECN 1917 in LB in 50 mL Erlenmeyer flasks with baffles. Shake at 37° C. for 16-20 hours.
2. Purchase organic baby spinach within 1-2 days of intended use. Spinach will be purchased from a variety of grocery stores, e.g., Wegman's, Stop & Shop, and Trader Joe's.
3. Centrifuge overnight cultures for 7 minutes at 3,000×g. Remove media and wash with 5 mL of sterile DI H2O. Centrifuge again for 7 minutes at 3,000×g. Resuspend in 2-3 mL of sterile DI H2O. ETEC aggregates more than ECN and requires more mixing to resuspend.
4. Dilute samples 10× and 100× in 96-well plate. Measure OD600 in spectrophotometer (shake once before measuring). Use calibration curve for the respective strain to approximate the concentrations. Dilute to appropriate high, mid, and low concentrations with DI H2O to a final volume of 30 mL in 50 mL centrifuge tubes. Aliquot 200 μL of each solution for quantification later. Store all E. coli solutions at 4-6° C. until ready for use.
5. Cut 12 mm spinach samples using the cookie-cutter. Obtain ˜100 spinach samples for each condition and place into 30 mL of E. coli solution in the 50 mL centrifuge tube. Lay the centrifuge tube on its side on a rocking platform shaker with tilt set to 10 and speed set to 4-5. Incubate the spinach samples in the E. coli solution at room temperature for 30 minutes.
6. Pour E. coli solution and spinach samples out onto a clean petri dish. Using tweezers, place 24 spinach samples on each petri dish. Each plate should either have all samples top-side up or bottom-side up.
7. Place the lids onto the petri dishes diagonally such that all spinach samples are covered but can air dry. Leave at room temperature for one hour. Samples are dried to reduce high-levels of reflectance due to light-scattering from large volume of water. Move plates to 6° C. and incubate for 48 hours.
8. Image plates with hyperspectral camera. Take care to not leave the spinach samples under the lights for excessive amounts of time to avoid heat exposure.
   E. coli Solution Quantification by Counting Colonies

For every experiment, three concentrations (high, mid, and low) for ETEC and ECN are used to dip the spinach samples. This protocol ensures that the concentrations of E. coli are comparable across the two strains and there is a clear separation between high, mid, and low concentrations. Samples which will be used to train the deep learning algorithm will be required to have a coefficient of variation (CV) less than 0.3.
1. Using the aliquots of the high, mid, low, and DI H2O conditions obtained in the protocol above, serially dilute to a concentration of ˜1 CFU/uL in a 96 well-plate in triplicate.
2. Plate 100 uL of the final dilution on LB plates. Incubate overnight.
3. Count colonies of each sample and calculate the concentration of the starting solutions. Ensure the CVs are lower than the threshold value.
   E. coli Transfer onto Spinach Samples
1. At step 5 of the spinach inoculation protocol, remove two samples at each concentration for each strain. Place the samples in 1 mL of fresh DI H2O. Vortex samples for 30 seconds to 1 minute.
2. Serially dilute to a concentration of ˜0.5-1.5 CFU/uL in a 96-well-plate. Plate 100 μL of the final dilutions on LB and/or MacConkey agar plates. Incubate overnight.

### Dataset Collection

It is understood that dataset collection can be performed in a variety of ways using any suitable equipment, such as the example equipment described herein.

In an example embodiment, a dataset can be classified with example controlled pathogen levels:
High concentration: 6E7 CFU/g
Mid concentration: 6E5 CFU/g
Low concentration: 6E3 CFU/g

| 48-hour imaging | 0-hour imaging |
|---|---|
| DI - 2,592 samples | DI - 1,920 samples |
| ETEC H1: 864, M1: 864, L1: 864 - | ETEC H1: 384, M1: 384, L1: 384 - |
| Total - 2592 samples | Total - 1,152 samples |
| ECN H2: 864, M2: 864, L2: 864 - | ECN H2: 480, M2: 480, L2: 480 - |
| Total - 2592 samples | Total - 1,344 samples |
| Total: 7,776 samples | Total: 4,416 samples |

Total samples: 12,192 samples

In some embodiments, a dataset is collected on abiotic surfaces, such as stainless steel. This enables detecting the presence of pathogen on common surfaces, including conveyer belts in food processing plants, various surfaces in hospitals, etc. Detection of objects is discussed in Siripatrawan, U., Y. Makino, Y. Kawagoe, and S. Oshita. “Rapid detection of Escherichia coli contamination in packaged fresh spinach using hyperspectral imaging.” Talanta 85, no. 1 (2011): 276-281, which is incorporated herein by reference.

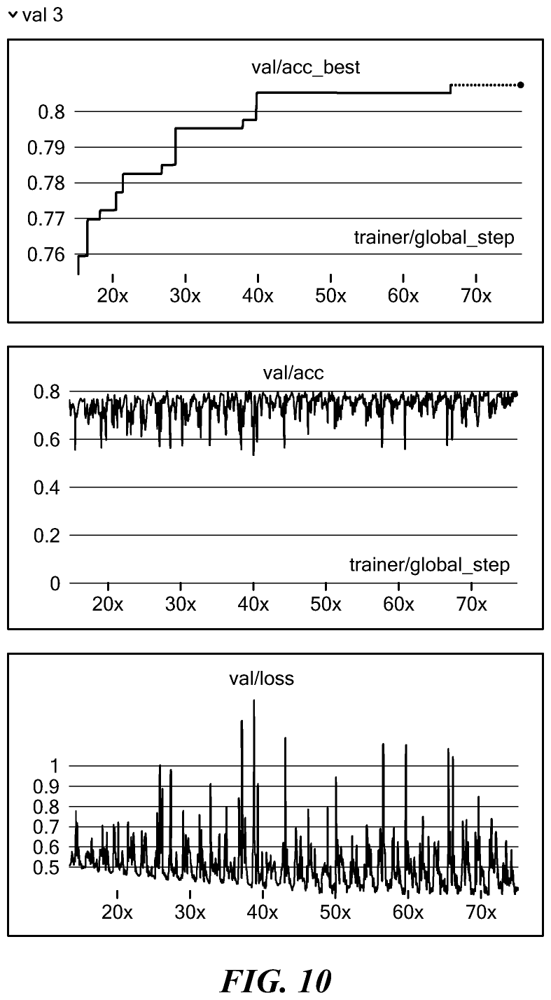

FIG. 10 shows classification results using example embodiments of the disclosure for ETEC vs DI. As can be seen, the validation accuracy for ETEC-Di is 80.9%. ETEC is a particular pathogenic strain of E-Coli. DI indicates de-ionized water, which acts as the uncontaminated sample. In the illustrated three figures, the first plot shows the best validation accuracy, the second plot shows the validation accuracy for each epoch, and the third plot shows the validation loss for each epoch.

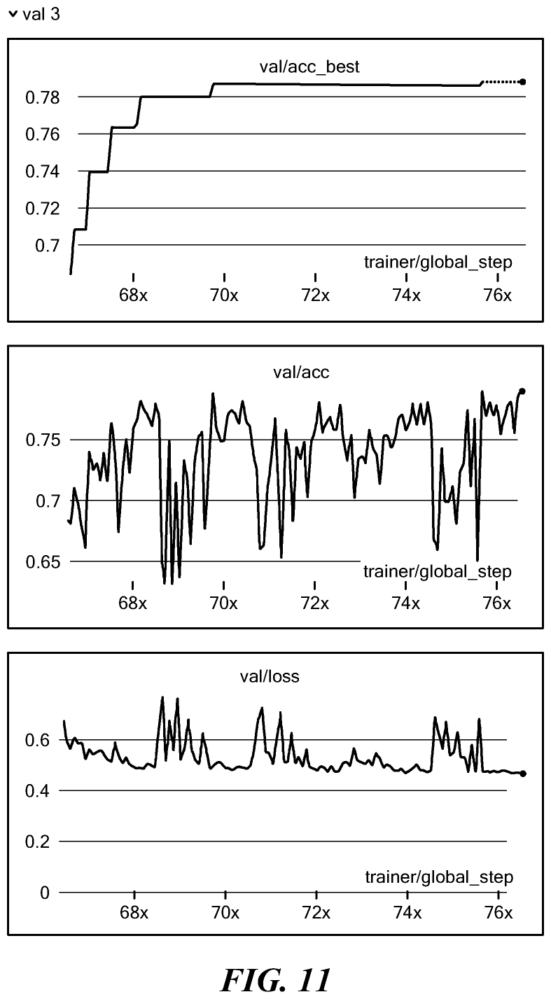

FIG. 11 shows classification results for ECN vs DI. Validation accuracy for ECN-Di is 79.09%. ECN is a non-pathogenic strain of E-coli. These two results constitute the first level of classification, i.e., contamination vs no-contamination.

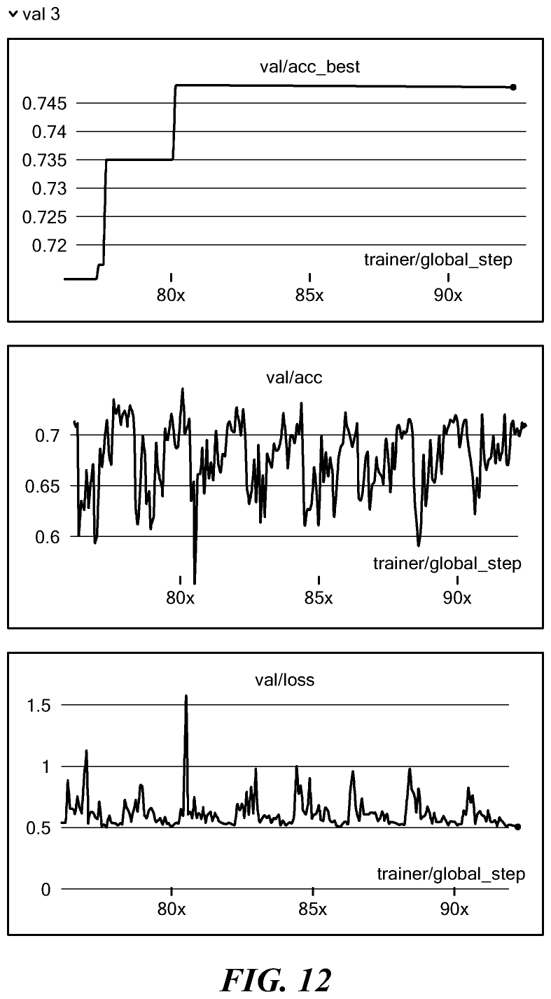

FIG. 12 shows validation accuracy for ETEC-ECN of 74.87%. This result indicates the second level of classification, i.e., classification of the type of contamination.

It should be appreciated that the systems and methods described herein are not limited to the detection of defects within or on objects, and in other exemplary embodiments, such systems and methods may be configured to detect other types of irregularities within or on objects.

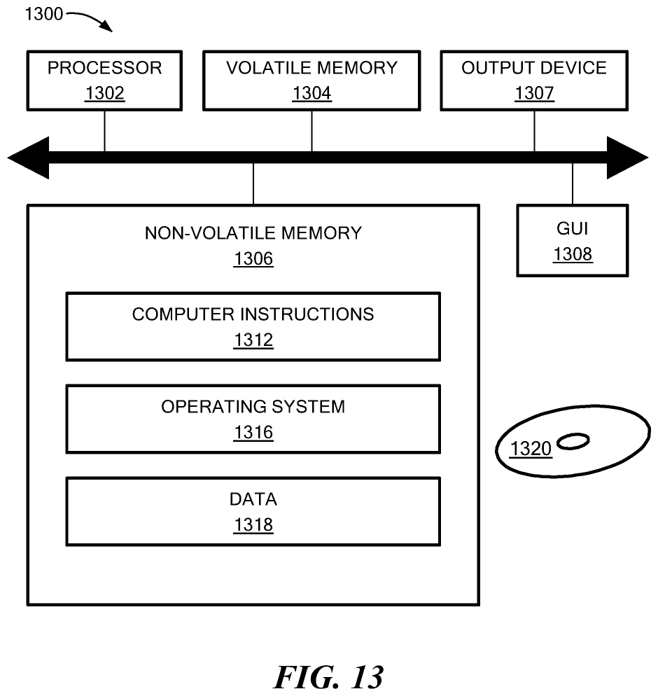

FIG. 13 shows an exemplary computer system, generally designated by reference number 1000, that can perform at least part of the processing described herein. For example, the computer system 1000 can perform processing to obtain sample HS images for AI analysis for defect detection, classification, and/or mapping, as described above. The computer 1000 includes a processor 1002, a volatile memory 1004, a non-volatile memory 1006 (e.g., hard disk), an output device 1007 and a graphical user interface (GUI) 1008 (e.g., a mouse, a keyboard, a display, for example). The non-volatile memory 1006 stores computer instructions 1012, an operating system 1016 and data 1018. In one example, the computer instructions 1012 are executed by the processor 1002 out of volatile memory 1004. In one embodiment, an article 1020 comprises non-transitory computer-readable instructions.

Processing may be implemented in hardware, software, or a combination of the two. Processing may be implemented in computer programs executed on programmable computers/machines that each include a processor, a storage medium, or other article of manufacture that is readable by the processor (including volatile and non-volatile memory and/or storage elements), at least one input device, and one or more output devices. Program code may be applied to data entered using an input device to perform processing and generate output information.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other units suitable for use in a computing environment. A computer program may be deployed to be executed on one computer or multiple computers at one site or distributed across multiple sites and interconnected by a communication network. A computer program may be stored on a storage medium or device (e.g., CD-ROM, hard disk, or magnetic diskette) that is readable by a general or special-purpose programmable computer for configuring and operating the computer when the computer reads the storage medium or device.

Processing may also be implemented as a machine-readable storage medium, configured with a computer program, where upon execution, instructions in the computer program cause the computer to operate.

Processing may be performed by one or more programmable embedded processors executing one or more computer programs to perform the functions of the system. All or part of the system may be implemented as special purpose logic circuitry (e.g., an FPGA (field programmable gate array) and/or an ASIC (application-specific integrated circuit)).

Having described exemplary embodiments of the disclosure, it will now become apparent to one of ordinary skill in the art that other embodiments incorporating their concepts may also be used. The embodiments contained herein should not be limited to disclosed embodiments but rather should be limited only by the spirit and scope of the appended claims. All publications and references cited herein are expressly incorporated herein by reference in their entirety.

Elements of different embodiments described herein may be combined to form other embodiments not expressly set forth above. Various elements described in the context of a single embodiment may also be provided separately or in any suitable subcombination. Other embodiments not specifically described herein are also within the scope of the following claims.

1. A system, comprising:
an imager configured to acquire images of a sample;
an artificial intelligence (AI) module, trained to identify, within multi-dimensional image data corresponding to images of objects, wavelength patterns corresponding to one or more defects within the objects; and
an analysis module configured to detect, using the AI module, one or more defects in the sample.

2. The system according to claim 1, wherein the analysis module is configured to classify and/or map the detected defect.

3. The system according to claim 1, wherein the imager comprises a multi-dimensional imager.

4-13. (canceled)

14. The system according to claim 1, wherein the AI module comprises a hypercomplex neural network.

15-19. (canceled)

20. The system according to claim 1, wherein the defects comprise pathogens, and the wavelength patterns each correspond to a particular pathogen.

21. (canceled)

22. (canceled)

23. The system according to claim 1, wherein the sample comprises food and the defects comprises pathogens.

24. The system according to claim 1, wherein the sample is an abiotic object and the defects comprise pathogens.

25-32. (canceled)

33. The system according to claim 1, wherein the imager further comprises a hyperspectral array imager comprising an array of unique wavelength filter lenses.

34-40. (canceled)

41. A method, comprising:
acquiring images of a sample with an imager; and
detecting, using an artificial intelligence (AI) module, one or more defects in the sample,
the AI module having been trained to identify, within multi-dimensional image data corresponding to images of objects, wavelength patterns corresponding to one or more defects within the objects.

42. (canceled)

43. The method according to claim 41, wherein the classifying and/or mapping comprises per-pixel processing and sub-pixel-level material classification.

44. The method according to claim 41, wherein the classifying and/mapping comprises Deep Hypercomplex based Reversible DR (DHRDR) processing for classification.

45. (canceled)

46. The method according to claim 41, wherein the step of acquiring images of a sample comprises collecting multi-dimensional data associated with the sample using a multi-dimensional imager.

47-53. (canceled)

54. The method according to claim 41, wherein the artificial intelligence module is trained with a training set of multi-dimensional images processed to classify spatio-spectral signatures for the defects.

55. (canceled)

56. (canceled)

57. The method according to claim 41, wherein the artificial intelligence module comprises a hypercomplex neural network.

58-63. (canceled)

64. The method according to claim 41, further comprising the step of reducing a number of dimensions of the multi-dimensional data.

65. (canceled)

66. The method according to claim 41, wherein the sample comprises food and the defects comprises pathogens.

67. The method according to claim 41, wherein the sample comprises an abiotic object and the defects comprise pathogens.

68-75. (canceled)

76. The method according to claim 41, wherein the imager further comprises a hyperspectral array imager comprising an array of unique wavelength filter lenses.

77. The method according to claim 41, further including employing a feature recalibration module for enhancing content of interest in the images of the object.

78-83. (canceled)

84. A system comprising:
(A) one or more processors; and
(B) a non-transitory computer readable medium operatively connected to the one or more processors having instructions stored thereon which, when executed by the one or more processors, cause the one or more processors to perform a method comprising:
acquiring images of a sample with an imager; and
detecting, using an artificial intelligence (AI) module, one or more defects in the sample by identifying wavelength patterns corresponding to the one or more defects, wherein the AI module has been trained to identify, within multi-dimensional image data corresponding to images of objects, wavelength patterns corresponding to one or more defects within the objects.
